(19) United States
(12) Patent Application Publication
(10) Pub. No.: US 2025/0218078 A1
(43) Pub. Date: Jul. 3, 2025

(54) PRODUCTION LINE CONFORMANCE MEASUREMENT TECHNIQUES USING INTELLIGENT IMAGE CROPPING AND CATEGORICAL VALIDATION MACHINE LEARNING MODELS

(71) Applicant: Optum, Inc., Minnetonka, MN (US)

(72) Inventors: Colby A. WRIGHT, Chandler, AZ (US); Thomas R. GILBERTSON, Cromwell, CT (US); Haylea Tricia PORTER, Simsbury, CT (US); Raja MUKHERJI, Dubliln (IE); Karen M. HARTE, Avon, CT (US); Connor David FERGESEN, Minneapolis, MN (US)

(21) Appl. No.: 18/403,220

(22) Filed: Jan. 3, 2024

(51) Int. Cl. G06T 11/60; G06Q 10/0639; G06V 10/24

(52) U.S. Cl. CPC G06T 11/60; G06Q 10/06395; G06V 10/242

(57) ABSTRACT

Various embodiments of the present disclosure provide image and prediction processing techniques for providing improved image-based prediction. The techniques may include generating a transformed image from a production line image corresponding to a primary orientation and the generating one or more derivative transformed images for the production line image, each corresponding to one of one or more derivative orientations from the primary orientation. The techniques may include generating, using a categorical validation machine learning model, a plurality of validation predictions for the production line image based on the transformed image and the one or more derivative transformed images. The techniques include generating an aggregate validation prediction based on the plurality of validation predictions and initiating the performance of the prediction-based action based on the aggregate validation prediction.

### BACKGROUND

Various embodiments of the present disclosure address technical challenges related to image-based prediction techniques, such as those used in the performance of production line conformance monitoring. Traditional image-based prediction techniques for production line conformance monitoring may employ machine learning models that are trained to generate predictions based on images taken on a production line. The predictions output by such models may be dependent on a plurality of aspects of the image, such as an orientation, lighting, noise, and/or the like. This, in turn, causes performance deficiencies, such as false negatives, due to aspects of an image, such as an orientation, lighting, noise, and/or the like, which are not predictive of the contents reflected by the image. Various embodiments of the present disclosure make important contributions to traditional image-based prediction techniques by addressing these technical challenges, among others.

### BRIEF SUMMARY

Various embodiments of the present disclosure provide image processing techniques that improve traditional image-based prediction techniques, such as those used in the performance of production line conformance monitoring. To do so, embodiments of the present disclosure provide methods, apparatus, systems, computing devices, computing entities, and/or the like for production line conformance monitoring that leverage categorical validation machine learning models generated using a plurality of training production line images associated with a related category subset of a plurality of validation categories for a target validation category. Some embodiments of the present disclosure improve the accuracy, reliability, and coverage of such models using various image and prediction processing techniques. For example, some techniques of the present disclosure may reduce false negatives and other performance deficiencies by generating a plurality of derivative transformed images from an input image, generating a plurality of individual predictions for the derivative transformed images, and aggregating the predictions to generate robust predictions for the input image that account for multiple derivatives thereof. In this manner, the performance of the machine learning models may be improved by intelligently augmenting and processing a plurality of derivative images from a single input image.

In some embodiments, a computer-implemented method includes generating, by one or more processors, a transformed image from a production line image corresponding to a primary orientation; generating, by the one or more processors, one or more derivative transformed images for the production line image, each corresponding to one of one or more derivative orientations from the primary orientation; generating, by the one or more processors and using a categorical validation machine learning model, a plurality of validation predictions for the production line image based on the transformed image and the one or more derivative transformed images; generating, by the one or more processors, an aggregate validation prediction based on the plurality of validation predictions; and initiating, by the one or more processors, the performance of a prediction-based action based on the aggregate validation prediction.

In some embodiments, a computing system includes memory and one or more processors communicatively coupled to the memory, the one or more processors are configured to generate a transformed image from a production line image corresponding to a primary orientation; generate one or more derivative transformed images for the production line image, each corresponding to one of one or more derivative orientations from the primary orientation; generate, using a categorical validation machine learning model, a plurality of validation predictions for the production line image based on the transformed image and the one or more derivative transformed images; generate an aggregate validation prediction based on the plurality of validation predictions; and initiate the performance of a prediction-based action based on the aggregate validation prediction.

In some embodiments, one or more non-transitory computer-readable storage media includes instructions that, when executed by one or more processors, cause the one or more processors to generate a transformed image from a production line image corresponding to a primary orientation; generate one or more derivative transformed images for the production line image, each corresponding to one of one or more derivative orientations from the primary orientation; generate, using a categorical validation machine learning model, a plurality of validation predictions for the production line image based on the transformed image and the one or more derivative transformed images; generate an aggregate validation prediction based on the plurality of validation predictions; and initiate the performance of a prediction-based action based on the aggregate validation prediction.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with one or more embodiments of the present disclosure.

FIG. 3 is a dataflow diagram showing example data structures and modules for generating predictions from production line images in accordance with some embodiments discussed herein.

FIG. 4 is a flowchart diagram of an example process for generating a categorical validation machine learning model for a target validation category in accordance with some embodiments discussed herein.

FIG. 5 is a flowchart diagram of an example process for generating a plurality of training production line images in accordance with some embodiments discussed herein.

FIG. 6 provides an operational example of a radio frequency-controlled container in a production line in accordance with some embodiments discussed herein.

FIG. 7 provides an operational example of a production line image in accordance with some embodiments discussed herein.

FIG. 8 is a flowchart diagram of an example process for performing one or more data augmentation operations on a set of transformed training production line images to update the set of transformed training production line images in accordance with some embodiments discussed herein.

FIG. 9 is a flowchart diagram of an example process for updating parameters of a categorical validation machine learning model based on a transformed training production line image in accordance with some embodiments discussed herein.

FIG. 10 is a flowchart showing an example prediction-based action process for intelligently initiating actions within a distribution facility in accordance with some embodiments discussed herein.

FIG. 11 is a flowchart diagram of an example process for performing one or more prediction-based actions based on a validation prediction for an input production line image with respect to a target validation category in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on,” “based at least on,” “based upon,” and/or similar words are used herein interchangeably in an open-ended manner such that they do not indicate being based only on or based solely on the referenced element or elements unless so indicated. Like numbers refer to like elements throughout. Moreover, while certain embodiments of the present disclosure are described with reference to predictive data analysis, one of ordinary skills in the art will recognize that the disclosed concepts may be used to perform other types of data analysis.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like). A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

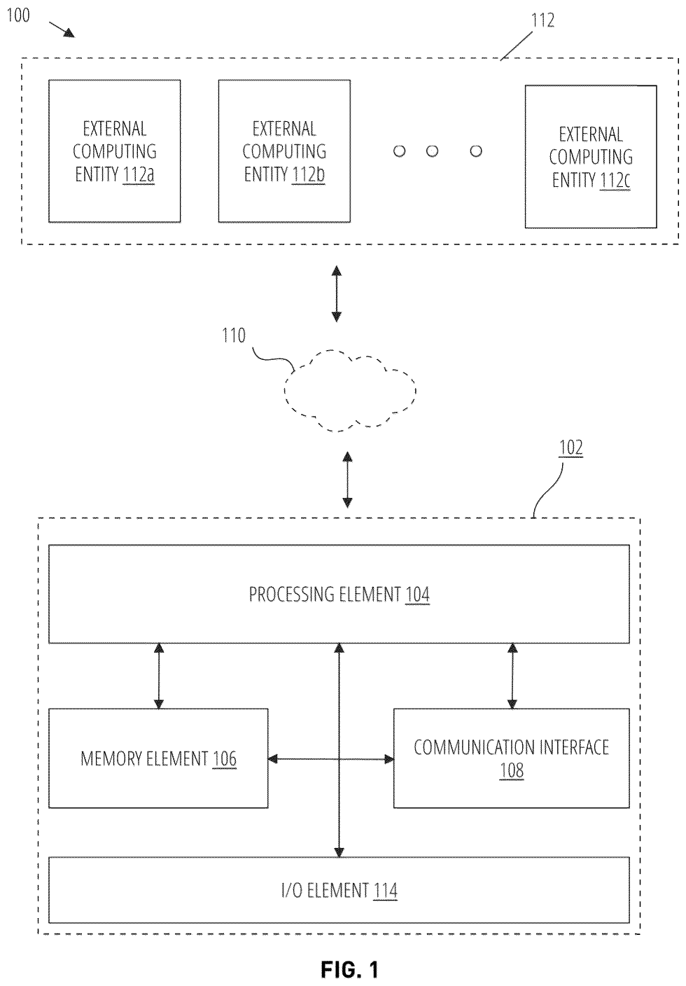

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., production line conveyance techniques, prediction techniques, training techniques, and/or the like) described herein.

The external computing entities 112a-c, for example, may include and/or be associated with one or more entities that may be configured to receive, store, manage, and/or facilitate datasets, such as the training dataset, imaging dataset, process control database, and/or the like. The external computing entities 112a-c may provide such datasets, and/or the like to the predictive computing entity 102 which may leverage the datasets to generate validation predictions, aggregate validation predictions, prediction-based action control instructions, and/or the like, as described herein. In some examples, the datasets may include an aggregation of data from across the external computing entities 112a-c into one or more aggregated datasets. The external computing entities 112a-c, for example, may be associated with one or more data repositories, cloud platforms, compute nodes, organizations, and/or the like, which may be individually and/or collectively leveraged by the predictive computing entity 102 to obtain and aggregate data for a prediction domain.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

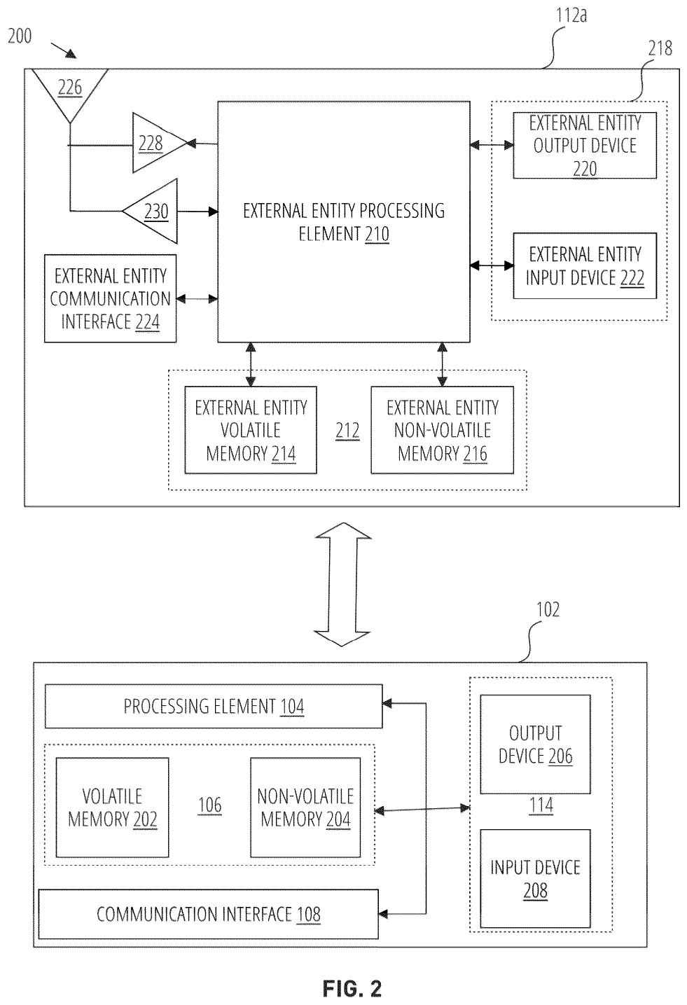

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more steps/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product which includes non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “production line image” refers to a data entity that describes an image captured at a location on a production line. The production line image, for example, may be captured by a camera located relative to (e.g., above, etc.) the location and configured to capture an image of a production line item on a production line as the production line item passes the location. An example of a production line item on a production line is a to-be-filled prescription progressing along steps of a production line in a radio frequency (RF)-controlled container called a puck, where inside the puck may be a pill bottle, and where a pharmacy production line software may, via the RF signals, control the progress of each puck. In some examples, if the production control equipment and software detect an error with the production line item (e.g., the pill bottle is significantly underweight, meaning it was not filled completely, etc.), the software may generate an exception and physically route the puck to a human for further inspection and/or resolution. In today's commercial pharmacy world, overhead images may be taken of each pill bottle and stored before they are capped and shipped. The production line image may include an overhead image that depicts an overhead view of pill bottle before the pill bottle is capped and dispatched for delivery to an end user, such as a pharmacy, individual, and/or the like.

In some embodiments, a plurality of production line images is captured by a plurality of different cameras positioned at various different locations of a production line. In some examples, one or more of the production line images may processed, using some of the techniques of the present disclosure, to detect an error associated with a production line item. In some examples, at least a portion of the production line images may be assigned a ground-truth label and stored as a plurality of training production line images. As described herein, the ground-truth label for each training production line image may identify a validation category and a validation result for a training production line image.

In some embodiments, a production line image is associated with one or more image attributes. Examples of image attributes may include a product type identifier and one or more physical production attributes. An example of a product type identifier may be a drug type identifier (e.g., a National Drug Code (NDC) identifier, etc.) for an object, such as a pill capsule (e.g., assigned to a puck container, a pill bottle, etc. that is imaged by a production line image, etc.). A physical production attribute may describe any property associated with the production line item reflected by a production line image. Examples of physical production attributes include a pharmacy site location identifier associated with a pharmacy site of a production line item, a fill line number associated with a fill line of a production line item, a camera identifier for a camera device used to capture a production line image of a production line item, attributes describing one or more camera/flash settings for a camera device used to capture a production line image of a production line item, attributes describing date and/or time of capture of a production line image of a production line item, and/or the like.

In some embodiments, the term “validation category” refers to a data entity that describes a category defined by a subset of image attributes, where validation predictions are generated with respect to the validation category. For example, a validation prediction may be generated with respect to a particular drug type identifier (e.g., NDC), where the validation predictions may describe whether corresponding production line images depict objects associated with the drug type identifier. As another example, validation predictions may be generated with respect to a particular drug type identifier and a particular pharmacy site location identifier, where the validation predictions may describe whether corresponding production line images depict objects associated with the drug type identifier that are generated at the particular pharmacy site location identifier. As yet another example, validation predictions may be generated with respect to a particular drug type identifier, a particular pharmacy site location identifier, and a particular fill line number, where the validation predictions may describe whether corresponding production line images depict objects associated with the drug type identifier that are generated at the particular fill line number of the particular pharmacy site location identifier. In general, any combination of one or more defined image attributes may be used to characterize a validation category.

In some embodiments, the term “color channel statistical distribution vector” refers to a data entity that is configured to describe, for each color channel of a set of color channels, a measure of statistical distribution (e.g., an average or other centroid measure) of color values associated with the color channel in pixels of a set of labeled production line images for a corresponding validation category. For example, given a validation category that is associated with a particular NDC identifier, and further given a Red-Green-Blue (RGB) color channel scheme, the color channel statistical distribution vector may describe: (i) an average pixel value for the red channel across labeled production line images that are assigned the particular NDC identifier, (ii) an average pixel value for the green channel across labeled production line images that are assigned the particular NDC identifier, and (iii) an average pixel value for the blue channel across labeled production line images that are assigned the particular NDC identifier. While various embodiments of the present disclosure describe using the color channels of the RGB color channel scheme, a person of ordinary skill in the relevant technology will recognize that other color channel schemes (e.g., Blue-Green-Red (BGR), Hue-Saturation-Lightness (HSL), Hue-Saturation-Value (HSV), the CIELAB color space (LAB), Red-Green-Blue-Alpha (RGBA), and/or the like) may be utilized. In some embodiments, the color channel statistical distribution vector for a validation category may describe statistical distribution measures of labeled production line images for the validation category across color channels defined by two or more color channel schemes.

In some embodiments, the term “neighboring category subset” refers to a data entity that is configured to describe a subset of a set of defined validation categories that are deemed similar to a target validation category based on comparing color channel statistical distribution vectors for the defined validation categories (where the set of defined validation categories includes the target validation category). For example, a neighboring category subset for a target validation category may describe an n-sized subset of a set of defined validation categories whose color channel statistical distribution vectors have the highest measures of similarity to the color channel statistical distribution vector of the target validation category (where n may, for example, be 20). In some embodiments, the measures of similarities of pairs of color channel statistical distribution vectors are determined using k-dimensional tree algorithms.

In some embodiments, the term “related category subset” refers to a data entity that is configured to describe a subset of the neighboring category subset for a target validation category, where the subset includes defined validation categories whose production line items are associated with respective shape feature descriptions that are determined to match a shape feature description of a production line item of the target validation category. In some embodiments, each defined validation category of the neighboring category subset is also in the related category subset if a shape descriptor data object of the defined validation category matches the shape descriptor object of the target validation category. A shape descriptor object may describe one or more shape-defining features of a product type identifier associated with a corresponding validation category, such as a shape-defining feature that describes whether pills associated with a pill category are round, oblong, capsule, teardrops, and/or the like. In some embodiments, shape data for NDCs are extracted from the Medispan database, which may be accessible at https://www.wolterskluwer.com/en/solutions/medi-span/medi-span/drug-data.

In some embodiments, the term “transformed image” may refer to a data entity that describes a production line image augmented by one or more image transformation operations. For instance, a transformed image may include a cropped image from a production line image. The cropped image may include a portion of the production line image that is reflective of a target object within the production line item. By way of example, in a pharmaceutical production line, a production line image may be reflective of an open pill bottle within a puck. The open pill bottle may include a plurality of unidentified objects (e.g., pill capsules, etc.) and the transformed image may include a portion of the production line image that reflects an area within the open pill bottle.

In some embodiments, the term “image transformation operation” refers to a set of operations for generating a transformed image from a production line image. An image transportation operation may include one or more image cropping operations, color enhancement operations, noise reduction operations, lightness correction operations, and/or the like.

By way of example, an image transformation operation may include one or more image cropping operations, such as: (i) a set of size-based crop operations that are configured to crop a production line image to a specific size (e.g., 224×224 pixels) starting at a predefined location (e.g., the top-left corner of the image) to generate a cropped image; (ii) a set of center crop operations to crop the production line image to a specific size (e.g., 224×224 pixels) relative to a center point of the image while maintaining an original aspect ratio to generate a cropped image; (iii) a set of vial removal crop operations on the production line image to generate a cropped image; and/or (iv) a set of sliding window intelligent crop operations (e.g., by using a sliding window object detection algorithm starting with a window size of 224×224 and a step size of five to detect and count the number of Binary Robust Invariant Scalable Keypoints (BRISKs) found in each of the sliding windows and selecting the sliding window containing the maximum number of BRISKs) on the production line image to generate a cropped image.

In addition, or alternatively, the image transformation operation may include one or more color enhancement operations, such as a color channel selection scheme in which one or more different color channel schemes may be leveraged based on a validation category associated with a production line image. In some examples, a color channel scheme may include adjusting a global contrast across image pixels of the cropped image to generate a transformed image (e.g., in order to help better distribute frequent intensity values and enhance over- or under-exposed sections of the fourth image). In some examples, an image transformation operation may include a mask operation that includes masking all pixels of an image to zero and replacing each pixel with the calculated mean of pixels in any given color channel across the image. The image transformation operations further include, if the selected color channel scheme is the LAB color channel scheme, transferring the L channel (representing lightness) of a specimen image (e.g., a specimen image selected by a human expert) for the target validation category associated with the production line image to the image to generate the transformed image.

In some embodiments, the term “vial removal crop operation” refers to one or more image cropping operations that are configured to crop an input image to remove an estimated vial area depicted in the input image. In some embodiments, the vial removal crop operation center crops an image to a defined size (e.g., 350×350 pixels) relative to a center point of an image. In some examples, the vial removal crop operations use a deep learning model to intelligently locate the vial in an input image. In some examples, a center point of the vial may be considered as the center point of the image.

In some embodiments, the term “sliding window intelligent crop operations” refers to one or more image cropping operations that are configured to generate an output image based on a recursively-generated sliding window of an input image. In some examples, a sliding window intelligent crop operation may be configured to (i) generate a set of sliding windows by using an image pyramid and a sliding window object detection algorithm starting with a window size of 224×224 and a step size of 5, (ii) for each sliding window, detect the number of BRISKs found in the sliding window, and (iii) select as the output image the sliding window with the highest number of detected BRISKs in the sliding window.

In some embodiments, the term “lightness correction operation” refers to an image transformation operation that is configured to describe a set of operations to replace an L channel of each input image with the L channel of a specimen image for a validation category. The specimen image, for example, may correspond to a product type identifier of a validation category, such as a specimen image for an NDC as selected by a human expert. Examples of performing the lightness correction operation may be described in Reinhard et al., Color Transfer Between Images, IEEE Computer Graphics and Applications (2001), available online at https://ieeexplore.ieee.org/abstract/document/946629.

In some embodiments, the term “primary orientation” refers to an orientation of a production line image. A primary orientation may be the orientation of an image as taken (e.g., without modification, etc.) by a camera. An orientation of a production line image may be changed by rotating the production line image to a derivative orientation.

In some embodiments, the term “derivative orientation” refers to an orientation of an image that is offset (e.g., by one or more degrees of rotation, etc.) from the primary orientation. A derivative orientation, for example, may include an orientation that is rotated from a primary orientation by one or more degrees. By way of example, a derivative orientation may include (i) a ninety-degree (e.g., 90°) derivative orientation that is rotated ninety-degrees in one direction from the primary orientation, (ii) a one-eighty-degree (e.g., 180°) derivative orientation that is rotated one-eighty-degrees in one direction from the primary orientation, (iii) a two-seventy-degree (e.g., 270°) derivative orientation that is rotated two-seventy-degrees in one direction from the primary orientation, and/or the like.

In some embodiments, the term “derivative transformed image” refers to an output image generated by applying one or more transformation operations to a production line image. A derivative transformed image, for example, may include a cropped image (e.g., cropped using one or more image cropping techniques, etc.), a light adjusted image (e.g., enhanced using one or more lightness correction operations, etc.), a rotated image (e.g., rotated to a derivative orientation, etc.). In some examples, a derivative transformed image may include a transformed image that is rotated to a derivative orientation. By way of example, a derivative transformed image may include (i) a ninety-degree derivative orientation image that is rotated ninety-degrees in one direction from the primary orientation, (ii) a one-eighty-degree derivative orientation image that is rotated one-eighty-degrees in one direction from the primary orientation, (iii) a two-seventy-degree derivative orientation image that is rotated two-seventy-degrees in one direction from the primary orientation, and/or the like.

In some embodiments, the term “categorical validation machine learning model” refers to a data entity that is configured to describe parameters, hyper-parameters, and/or defined operations of a machine learning model that is configured to determine whether an input production line image corresponds to a target validation category that is associated with the categorical validation machine learning model. In some embodiments, the categorical validation machine learning model is configured to process at least one of the production line image (e.g., as a matrix), extracted image-based feature values associated with the input production line image (e.g., as a vector), and/or one or more physical production attributes for the input production line image (e.g., as a vector), in order to determine a validation prediction for the input production line image that describes whether an input production line image corresponds to a target validation category that is associated with the categorical validation machine learning model.

In some embodiments, the categorical validation machine learning model includes a convolutional neural network, such as a binary classification convolutional neural network, that is characterized by at least one (i) five layers including four two-dimensional convolutional layers and one flattening layer, (ii) filters that are increased across the two-dimensional convolutional layers to capture patterns and details in the input image, and/or (iii) each 2-dimensional convolutional layer utilizes a rectified linear unit (ReLU) activation function. In some embodiments, each two-dimensional convolution operation in a two-dimensional convolutional layer is followed by a pooling operation (e.g., with a size and stride of two), where dropout values are increased across two dimensional convolutional layers to a maximum value (e.g., a maximum value of 0.7). In some embodiments, the categorical validation machine learning model is trained using a binary cross-entropy loss function, with constant label smoothing (e.g., constant label smoothing at 0.1 to train the model with mislabeled data and with improved overall robustness and accuracy). In some embodiments, to train the categorical validation machine learning model, an optimization function such as Adam Optimizer function or a Stochastic gradient descent optimizer function is utilized. While various embodiments of the present disclosure describe that the categorical validation machine learning model includes a convolutional neural network, a person of ordinary skill in the relevant technology will recognize that any machine learning model (e.g., any neural network, such as any pre-trained neural network) may be utilized as part of the categorical validation machine learning model.

In some embodiments, the term “extracted image-based feature” may refer to a data entity that is configured to describe an extracted feature of a production line image that is extracted from the image data of the production line image and/or derivative transformed images associated therewith. Examples of extracted image-based features include key point descriptors for the production line image, such as key point descriptors generated by decomposing the production line image to key points that represent a unique feature (e.g., using BRISK feature detection techniques that decompose the production line image (and/or derivative transformed images associated therewith) to key points that represent a unique feature defined in a 128-vector descriptor). Some techniques for generating key point descriptors for production line images are described in Zheng et al., An Algorithm for Accuracy Enhancement of License Plate Recognition, Journal of Computer and System Sciences (2013), available online at https://www.sciencedirect.com/science/article/pii/S0022000012001018.

In some embodiments, the term “physical production attribute” refers to a data entity that is configured to describe a property associated with production of the production line associated with a production line image. Examples of physical production attributes include a pharmacy site location identifier associated with a pharmacy site of a production line item, a fill line number associated with a fill line of a production line item, a camera identifier for a camera device used to capture a production line image of a production line item, attributes describing one or more camera/flash settings for a camera device used to capture a production line image of a production line item, attributes describing date and/or time of capture of a production line image of a production line item, and/or the like.

In some embodiments, the term “categorical validation ensemble model” refers to a plurality of categorical machine learning models. A categorical validation ensemble model, for example, may include a separate categorical machine learning model for each validation category associated with a production line. In some examples, for a pharmaceutical production line, a categorical validation ensemble model may include a separate categorical machine learning model for each NDC of a plurality of NDC processed by the pharmaceutical production line.

In some embodiments, the term “validation prediction” refers to a data entity that is configured to describe a conclusion about whether a corresponding production line image that is associated with the validation prediction is associated with a corresponding validation category. For example, the validation prediction may describe (i) a likelihood that a corresponding production line image that is associated with the validation prediction describes an object for a validation category that is associated with the validation prediction, (ii) a likelihood that a corresponding production line image that is associated with the validation prediction does not describe an object for a validation category that is associated with the validation prediction, and/or the like. By way of example, a validation prediction may include a prediction score indicative of an affirmative and/or negative category likelihood. The prediction score may include a binary number (e.g., 0 or 1), a numerical range, a ratio, a percentage, and/or the like. In some examples, the prediction score may include a number between zero and one.

In some embodiments, a validation prediction describes at least one of an affirmative category likelihood for the production line image and/or a negative category likelihood for the production line image. In some embodiments, a validation prediction describes at least one of a smoothed affirmative likelihood for the production line image and/or a smoothed negative category likelihood for the production line image. An affirmative category likelihood may describe a value generated by the categorical validation machine learning model that describes a likelihood that an input image provided as an input to the categorical validation machine learning model (e.g., during training, a training production line image) corresponds to a validation category associated with the categorical validation machine learning model. A negative category likelihood may describe a value generated by the categorical validation machine learning model that describes a likelihood that an input image provided as an input to the categorical validation machine learning model (e.g., during training, a training production line image) does not correspond to a validation category associated with the categorical validation machine learning model. In some embodiments, the affirmative category likelihood and/or the negative category likelihood are processed using a likelihood smoothing transformation to determine a smoothed affirmative likelihood and/or a smoothed negative category likelihood.

In some embodiments, determining the validation prediction includes determining an initial validation score based on one or more outputs of the categorical validation machine learning model; determining an adjusted validation score based on adjusting the initial validation score using a false positive penalty weight and a false negative penalty weight; and determining the validation prediction based on the adjusted validation score.

In some embodiments, the term “aggregate validation prediction” refers to a combination of a plurality of validation prediction scores. An aggregate validation prediction, for example, may include a single value (and/or vector, etc.) that represents a plurality of validation predictions. An aggregate validation prediction may be generated by applying one or more aggregation operations to the plurality of validation prediction scores. For example, an aggregate validation prediction may include a maximum prediction score, a minimum prediction score, an average prediction score, a median prediction score, and/or any other score for representing an attributed of a plurality of validation prediction scores. By way of example, an aggregate validation prediction may include an average of a plurality of validation prediction scores.

In some embodiments, the term “process control database” refers to a set of one or more data entities (e.g., a set of data entities stored in a distributed manner) that contain data for a database that describes, for each validation category of a set of defined validation categories, an action threshold for the validation category and the one or more process control parameters for the validation category, where the action threshold for the validation category may describe a condition that, when satisfied by the validation prediction for a production line image with respect to the validation category, causes performance of one or more production line control actions based on one or more process control parameters associated with the validation category. For example, the action threshold may recommend that, when a validation prediction for a production line image with respect to a corresponding validation category exceeds a particular numeric value, the one or more production line control actions for the corresponding validation category should be performed. As another example, the action threshold may recommend that, when a validation prediction for a production line image with respect to a corresponding validation category falls below a particular numeric value, the one or more production line control actions for the corresponding validation category should be performed.

In some embodiments, the process control database may describe, for each validation category of a set of defined validation categories, specific image transformation requirements and measurement parameters associated with the validation category, such as properties associated with the crop, enhancement, and measurement transformations for the validation category. In some embodiments, the process control database may describe data associated with each validation category in a row of a relational database, where the row is associated with the validation category. In some embodiments, the process control database may describe data associated with each validation category in a column of a relational database, where the column is associated with the validation category.

In some examples, a process control database may define a hierarchical threshold scheme. The hierarchical threshold scheme may define a plurality of action thresholds, each corresponding to a particular prediction-based action associated with a production line. For instance, the hierarchical threshold scheme may define a first action threshold for a first prediction-based action as a first numerical value, range, etc. that, if achieved by a validation prediction, aggregate validation prediction, and/or the like, may cause a performance of the first prediction-based action. In addition, or alternatively, the hierarchical threshold scheme may define a second action threshold for a second prediction-based action as a second numerical value, range, etc. that, if achieved by a validation prediction, aggregate validation prediction, and/or the like, may cause a performance of the second prediction-based action. The second action threshold may be less than (or greater, etc.) the first action threshold, such that a second prediction-based action may be performed in the event that a validation prediction, aggregate validation prediction, and/or the like achieves a second action threshold but not the first action threshold. In some examples, the hierarchical threshold scheme may define at least one of a clearance threshold, a reimaging threshold, an image review threshold, a manual inspection threshold, and/or the like, each corresponding to a respective prediction-based action.

In some embodiments, the term “prediction-based action” refers to an action that may be performed for a production line item based on a prediction, such as the validation predictions and/or aggregate validation predictions described herein. In some examples, a prediction-based action may include a plurality of line routing actions that each correspond to a different action threshold.

In some embodiments, the term “action threshold” refers to a validation prediction threshold that corresponds to a particular production line routing action. An action threshold, for example, may include a numerical range, a numerical value, and/or the like that describes a criterion for evaluating a validation and/or aggregate validation prediction. An action threshold, for example, may include minimum value (e.g., percentage, etc.) for performing a particular production line routing action.

In some embodiments, the term “production line routing action” refers to a prediction-based action that is performed by one or more control components of a production line. A production line routing action, for example, may include one or more control operations for controlling a motor (and/or other control mechanism) of a conveyance assembly to initiate a movement of a production line item from an origin location to a destination location. A production line routing action may include a movement of a conveyor belt to move a production line item in a forward direction. In addition, or alternatively, a production line routing action may include a movement of one or more diverting assemblies to reroute a production line item on a conveyance assembly.

In some embodiments, the term “clearance action” refers to a production line routing action that moves a production line item in a forward direction without rerouting the production line item for further inspection. A clearance action, for example, may include a pass routing action allowing the production line item to proceed. In some examples, a clearance action may correspond to a clearance threshold. In some examples, a clearance threshold may be a highest (or lowest) threshold in a hierarchical threshold scheme.

In some embodiments, the term “reimage action” refers to a production line routing action that diverts a production line item for further inspection. A reimage action, for example, may include diverting a production line item to another camera system for performing one or more imaging operations, as described herein, to generate one or more second validation predictions and/or aggregate validation predictions. In some examples, a reimaging action May further include routing a production line item to a shuffling machine to reshuffle one or more contents within the production line item. In some examples, a reimage action may correspond to a reimage threshold. In some examples, a reimage threshold may be a lower (or higher) threshold relative to a clearance threshold, but higher than one or more other thresholds (e.g., an image review threshold, etc.) in a hierarchical threshold scheme.

In some embodiments, the term “image review action” refers to a production line routing action that diverts a production line item for further inspection. A manual inspection action, for example, may include a minor routing action which allows the production line item to be verified based on the production line image. For example, a process control action may be triggering an exception that causes a user interface depicting the production line image as well as the physical production attributes of the production line image to be presented to the human inspector. In some examples, an image review action may correspond to an image review threshold. In some examples, an image review threshold may be a lower (or higher) threshold relative to a reimage threshold, but higher than one or more other thresholds (e.g., a manual inspection threshold, etc.) in a hierarchical threshold scheme.

In some embodiments, the term “manual inspection action” refers to a production line routing action that diverts a production line item for further inspection. A manual inspection action, for example, may include a major routing action which requires a manual verification of the contents in a production line item. A manual inspection action may include triggering an exception that causes a production line item associated with a production line image to be diverted to a human inspector. A manual inspection action may be triggering an exception that causes a production line item associated with a production line image to be diverted to a human inspector and a user interface depicting the production line image to be presented to the human inspector. In some examples, a manual inspection action may correspond to a manual inspection threshold. In some examples, a manual inspection threshold may be a lowest (or highest) in a hierarchical threshold scheme.

### IV. Overview and Technical Improvements

Various embodiments of the present disclosure provide image processing techniques that improve traditional image-based prediction techniques, such as those used in the performance of production line conformance monitoring. To do so, embodiments of the present disclosure provide methods, apparatus, systems, computing devices, computing entities, and/or the like for production line conformance monitoring that leverage categorical validation machine learning models generated using a plurality of training production line images associated with a related category subset of a plurality of validation categories for a target validation category. Some embodiments of the present disclosure improve the accuracy, reliability, and coverage of such models using various image and prediction processing techniques. For example, some techniques of the present disclosure may reduce false negatives and other performance deficiencies by generating a plurality of derivative transformed images from an input image, generating a plurality of individual predictions for the derivative transformed images, and aggregating the predictions to generate robust predictions for the input image that account for multiple derivatives thereof. In this manner, the performance of the machine learning models may be improved by intelligently augmenting and processing a plurality of derivative images from a single input image.

Various embodiments of the present disclosure provide techniques for efficiently and reliably performing conformance monitoring of a production line in order to determine defective/non-conformant production line items. For example, various embodiments of the present disclosure utilize systems, methods, and computer program products that perform production line conformance monitoring by utilizing categorical validation machine learning models that are generated using a plurality of training production line images associated with a related category subset of a plurality of validation categories for a target validation category. By enabling conformance monitoring of a production line, various embodiments of the present disclosure reduce the cost to production line control systems resulting from manual conformance monitoring and remove the need for operations needed to enable human agents to perform manual conformance monitoring. Moreover, by enabling conformance monitoring of a production line, various embodiments of the present disclosure reduce or remove the need for operations needed to address the presence of defective products resulting from unreliable conformance monitoring of the production line, such as operations needed to enable human agents to perform manual conformance monitoring of later-stage products that exist in a production process after the production line. By enabling the noted functionalities and associated advantages, various embodiments of the present disclosure reduce the operational load on production line control systems and thus improve the operational efficiency and the operational reliability of the noted production line control systems.

An exemplary application of various embodiments of the present disclosure relates to validating and confirming whether pills contained in a vial are the correct pills identified by a pill identifier. For example, various embodiments of the present disclosure train and implement binary classification convolutional neural network models to generate a signal indicating whether a ground truth identity of the pills matches a predicted identity based on a provided pill identifier. A key benefit of various embodiments of the present disclosure is to ensure and validate that incorrect medication is not administered and distributed. Various health risks arise when an incorrect medication is consumed; thus, various embodiments of the present disclosure may serve as a vital tool to prevent or reduce occurrence of such health risks. Various embodiments of the present disclosure may also be applied to detecting foreign bodies inadvertently contained or packaged with pills in a vial.

Various embodiments of the present disclosure are configured to collect and process training data in order to train models in order to distinguish pills of a target NDC from other pills. A training set of images is intentionally selected and processed before being provided to the models for training. That is, various embodiments of the present disclosure provide operations for selecting a training dataset, and selecting the training dataset may be based on an identification of a cohort of similar NDCs to a target NDC for which the training dataset is relevant.

A large set of potential training images may be received, and the set contains potential training images identifying different pills identified by various NDCs. The large set may first be filtered by removing blurry and high brightness images. Each potential training image is processed and associated with a blurriness value and a brightness value. The blurriness value may be determined based on a variance of the Laplacian transform of the potential training image after being processed by a Gaussian Edge Detection algorithm. The brightness value may be determined based on a root mean square of pixel values of the potential training image. Specifically, in some embodiments, potential training images with blurriness values under 6 and brightness values greater than 200 are removed from the large set to form a filtered set. Each potential training image in the filtered set is then cropped using center crop or other cropping methods. An average color for each NDC identifying pills in the filtered set of images is then determined. In some examples, a separate set of 1,000 labelled images for each NDC is used to determine an average color; however, in other examples, images in the filtered set may also be used to determine an average color for each NDC. Specifically, an average pixel value may be determined per channel (e.g., each channel in a RGB color space) to determine an average color for each NDC.

Using a k-dimensional tree algorithm based on each average color of the NDCs, a number of similar or “nearest neighbor” NDCs are identified for each NDC. In some examples, 20 similar NDCs are identified. Thus, as a result, each NDC is associated with a number (e.g., 20) of similar NDCs. The number of similar NDCs to the target NDC is then filtered by removing NDCs that do not have the same physical characteristic as the target NDC in at least one regard. For example, NDCs with different shapes (e.g., round, oblong, capsule, teardrop) are removed to result in a cohort of similar NDCs to the target NDC. The physical characteristics, such as pill shape, may be obtained from publicly available NDC data. As a result, then, only training images of pills identified by the cohort of similar NDCs to the target NDC are used to train one or more models for the target NDC. In some examples, the number of similar NDCs in the cohort is less than or equal to 20. This process of determining a cohort of similar NDCs to obtain a training dataset may be repeated for different target NDCs. Clearly, identifying a cohort of similar NDCs is advantageous in narrowing training datasets and thereby increasing the efficacy of the models to distinguish pills of the target NDC to similar looking pills identified by the cohort of similar NDCs.

One or more models for distinguishing pills of a target NDC from other pills may be trained on a training set of images selected based on the cohort of similar NDCs to the target NDC. Each image in the training set may be processed using one or more image transformations before being used to train the models. Various image transformations may be performed on each image in the training set based on the target NDC. Further, various image transformations may be performed on each image in the training based on a combination of the target NDC and other data such as Physical Fill Attributes (PFAs). For example, Physical Fill Attributes may include pharmacy site location, fill line number, camera identifier, camera and flash settings, data, and/or time. Thus, for example, different image transformations may be performed to train models for pills of a target NDC in images taken by a first camera and to train models for pills of the same target NDC in images taken by a second camera. Images in the training set may be processed by performing one or more of the following image transformations. Images may be cropped. Specifically, images may be cropped to a specific size, cropped from the center of the image, cropped to remove the vial containing the pills from the image (e.g., by using a deep learning model to locate the vial in the image), cropped to a window containing a maximum number of key or important features (e.g., using Sliding Window Intelligent Crop and cropping to a window containing a maximum number of Binary Robust Invariant Scalable Keypoints (BRISK)).

As another transformation, images may be enhanced and/or normalized. Various enhancing and normalizing operations may be based on a selected color space for each image. Lightness correction may be performed for images in the LAB color space. Lightness correction involves transferring the L channel (representing lightness) from a specimen image representing a particular NDC to images in the training set of the same particular NDC. The specimen image may be an image representative of the particular NDC and selected by a human user or an AI prediction model. Histogram equalization may be performed for images in the RGB color space. Histogram equalization adjusts global contrast across image pixels to better distribute frequent intensity values, thereby enhancing over or under exposed portions of the image. Specifically, histogram equalization may calculate a cumulative distribution function for pixel values of an image, masking all pixel values to 0, and replacing the pixel values with a calculated mean pixel value for each channel (e.g., R channel, G channel, B channel in RGB color space). BRISK feature detection may be performed to identify dense areas of key points in an image (typically representative of an imprint on the surface of a pill), which may then be used to feature match between different images for image alignment.

In some embodiments, image parameters may be measured. Blurriness and brightness values may be determined for each image in the training set. As mentioned, blurriness may be based on a variance of a Laplacian transform of an image processed via Gaussian Edge Detection algorithm, and brightness may be based on the root mean square on pixel values. Images with a blurriness value below 6 may be labelled as blurry, and images with a brightness value greater than or equal to 200 may be labelled as bright.

Some embodiments describe a system including the trained models and/or the datastore containing the trained models and other data that may receive an image of pills in a vial and be tasked with determining whether the pills are pills identified by a specific NDC. In such examples, the system may implement a software Application Programming Interface (API) and receive an API call, which may include an input image of pills in a vial, a NDC representing the suspected identity of the pills in the input image, and other data such as PFAs, and subsequently generate and return an API response with an indication or signal whether the pills identified in the input image are correctly identified by received NDC. Then, a row in the datastore may be identified that corresponds to the received NDC and/or PFAs. In some examples, if no row is identified to correspond to the received NDC and/or PFAs, the system generates an exception signal indicating that the pills identified in the input image are not correctly identified by the received NDC. Otherwise, the input image may be measured for blurriness and brightness and may also be transformed according to the model-specific transformations indicated by the row in the datastore. The transformed input image is then passed to the one or more CNN models indicated by the row in the datastore. Image measurements and the model results are compared to threshold values indicated by the row in the datastore using rules indicated by the row in the datastore. Based on the evaluation of the rules, an output signal may be generated and provided. The output signal may be configured to indicate whether the pills in the input image match the received NDC. Specifically, the output signal may comprise values representing “Exception,” “Not Exception,” or “Error.” Based on the output signal, various actions may be performed. For example, an “Exception” output signal may cause the vial identified by the input image to be redirected to a human pharmacist or technician for manual validation. As another example, an “Exception” output signal may cause the vial identified by the input image to be refilled with new pills, and the system may reevaluate based on another input image taken of the vial with new pills. In some examples, a separate output signal may be provided to indicate that a foreign object is detected in the input image. In some examples, the input image may be used to retrain or further train one or more CNN models.

The above-described process may improve traditional machine learning models with respect to detecting a plurality of different production line items. However, the effectiveness of the image processing techniques may be hampered by image characteristics, such as orientation, and/or other features that are irrelevant to a prediction. To account for such inefficiency, one or more image processing techniques of the present disclosure enable the augmentation of an input image to generate a plurality of derivative images. The derivative images, for example, may correspond to a plurality of different orientations of the input image. Each of the derivative images may be individually processed to generate a plurality of different predictions for the input image. The predictions may then be aggregated to generate a robust, aggregate prediction that accounts for each of a plurality of different variations of the input image. In the way, the predictive performance of a machine learning model may be improved, for example, by reducing false negatives and/or other performance deficiencies traditionally caused by irrelevant image characteristics.

Examples of technologically advantageous embodiments of the present disclosure include: (i) categorical machine learning models for generating predictions tailored to various production line items within a distribution facility, (ii) training techniques for generating training data and training categorical machine learning models, (iii) image and prediction processing techniques for augmenting image-based predictions, among other aspects of the present disclosure. Other technical improvements and advantages may be realized by one of ordinary skill in the art.

### V. Example System Operations

As indicated, various embodiments of the present disclosure make important technical contributions to image-based prediction techniques. In particular, systems and methods are disclosed herein that implement image and prediction processing techniques to improve machine learning model performance with respect to image predictions. By doing so, improved predictions may be generated, using machine learning models, that directly address traditional model deficiencies, such as false negatives due to orientation specific errors. As described herein, these predictions may be leveraged to improve various prediction-based actions, which may result in improved automation techniques within distribution facilities.

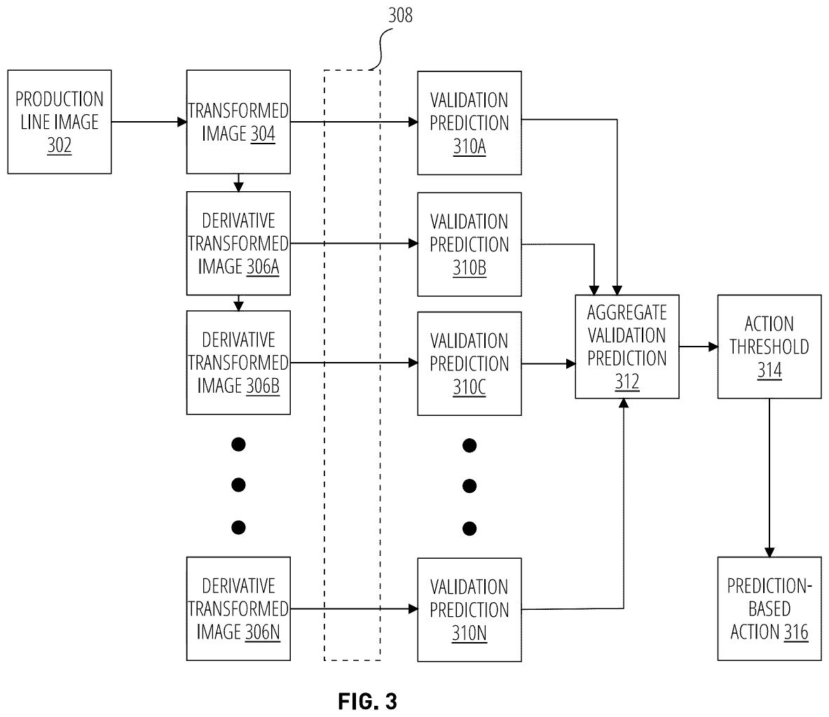

FIG. 3 is a dataflow diagram 300 showing example data structures and modules for generating predictions from production line images in accordance with some embodiments discussed herein. The dataflow diagram 300, for example, illustrates an intelligent image transformation process for generating an aggregate validation prediction 312 for a production line image 302 based on a plurality of derivative transformed images 306A-N that consider a plurality of different orientations of the production line image 302. In this way, distinct orientation-specific predictions may be leveraged to improve overall machine learning predictions by reducing false negatives due to orientation related inaccuracies without expending substantial computing resources.

In some embodiments, a transformed image 304 is generated from a production line image 302 corresponding to a primary orientation. In some embodiments, the production line image 302 is a data entity that describes an image captured at a location on a production line. The production line image 302, for example, may be captured by a camera located relative to (e.g., above, etc.) the location and configured to capture an image of a production line item on a production line as the production line item passes the location. An example of a production line item on a production line is a to-be-filled prescription progressing along steps of a production line in a radio frequency (RF)-controlled container called a puck, where inside the puck may be a pill bottle, and where a pharmacy production line software may, via the RF signals, control the progress of each puck to process the pill bottle in accordance with a prescription. In some examples, if the production control equipment and software detect an error with the production line item (e.g., the pill bottle is significantly underweight, meaning it was not filled completely, etc.), the software may generate an exception and physically route the puck to a human for further inspection and/or resolution. In today's commercial pharmacy world, overhead images may be taken of each pill bottle and stored before they are capped and shipped. The production line image 302 may include an overhead image that depicts an overhead view of pill bottle before the pill bottle is capped and dispatched for delivery to an end user, such as a pharmacy, individual, and/or the like.

In some embodiments, a plurality of production line images 302 is captured by a plurality of different cameras positioned at various different locations of a production line. In some examples, one or more of the production line images 302 may processed, using some of the techniques of the present disclosure, to detect an error associated with a production line item. In some examples, at least a portion of the production line images 302 may be assigned a ground-truth label and stored as a plurality of training production line images. As described herein, the ground-truth label for each training production line image may identify a validation category and a validation result for a training production line image.

In some embodiments, a production line image 302 is associated with one or more image attributes. Examples of image attributes may include a product type identifier and one or more physical production attributes. An example of a product type identifier may be a drug type identifier (e.g., a NDC identifier, etc.) for an object, such as a pill capsule (e.g., assigned to a puck container, a pill bottle, etc. that is imaged by a production line image, etc.). A physical production attribute may describe any property associated with the production line item reflected by a production line image 302. Examples of physical production attributes include a pharmacy site location identifier associated with a pharmacy site of a production line item, a fill line number associated with a fill line of a production line item, a camera identifier for a camera device used to capture a production line image 302 of a production line item, attributes describing one or more camera/flash settings for a camera device used to capture a production line image 302 of a production line item, attributes describing date and/or time of capture of a production line image 302 of a production line item, and/or the like.

In some embodiments, a transformed image 304 is a data entity that describes a production line image 302 augmented by one or more image transformation operations. For instance, a transformed image 304 may include a cropped image from a production line image 302. The cropped image may include a portion of the production line image 302 that is reflective of a target object within the production line item. By way of example, in a pharmaceutical production line, a production line image 302 may be reflective of an open pill bottle within a puck. The open pill bottle may include a plurality of unidentified objects (e.g., pill capsules, etc.) and the transformed image 304 may include a portion of the production line image 302 that reflects an area within the open pill bottle.

In some embodiments, an image transformation operation is a set of operations for generating a transformed image 304 (and/or portion thereof) from a production line image 302. An image transportation operation may include one or more image cropping operations, color enhancement operations, noise reduction operations, lightness correction operations, and/or the like.

By way of example, an image transformation operation may include one or more image cropping operations, such as: (i) a set of size-based crop operations that are configured to crop a production line image 302 to a specific size (e.g., 224×224 pixels) starting at a predefined location (e.g., the top-left corner of the image) to generate a cropped image; (ii) a set of center crop operations to crop the production line image 302 to a specific size (e.g., 224×224 pixels) relative to a center point of the image while maintaining an original aspect ratio to generate a cropped image; (iii) a set of vial removal crop operations on the production line image 302 to generate a cropped image; and/or (iv) a set of sliding window intelligent crop operations (e.g., by using a sliding window object detection algorithm starting with a window size of 224×224 and a step size of five to detect and count the number of Binary Robust Invariant Scalable Keypoints (BRISKs) found in each of the sliding windows and selecting the sliding window containing the maximum number of BRISKs) on the production line image 302 to generate a cropped image.

In addition, or alternatively, the image transformation operation may include one or more color enhancement operations, such as a color channel selection scheme in which one or more different color channel schemes may be leveraged based on a validation category associated with a production line image. In some examples, a color channel scheme may include adjusting a global contrast across image pixels of a cropped image to generate a transformed image 304 (e.g., in order to help better distribute frequent intensity values and enhance over- or under-exposed sections of the fourth image). In some examples, an image transformation operation may include a mask operation that includes masking all pixels of an image to zero and replacing each pixel with the calculated mean of pixels in any given color channel across the image. The image transformation operations may further include, if the selected color channel scheme is the LAB color channel scheme, transferring the L channel (representing lightness) of a specimen image (e.g., a specimen image selected by a human expert) for a target validation category associated with the production line image 302 to the image to generate the transformed image 304.

In some embodiments, a vial removal crop operation is one or more image cropping operations that are configured to crop an input image, such as the production line image 302, to remove an estimated vial area depicted in the input image. In some embodiments, the vial removal crop operation center crops an image to a defined size (e.g., 350×350 pixels) relative to a center point of an image. In some examples, the vial removal crop operations use a deep learning model to intelligently locate the vial in an input image. In some examples, a center point of the vial may be considered as the center point of the image.

In some embodiments, a sliding window intelligent crop operations is another of one or more image cropping operations that are configured to generate an output image, such as the transformed image 304, based on a recursively-generated sliding window of an input image (e.g., production line image 302). In some examples, a sliding window intelligent crop operation may be configured to (i) generate a set of sliding windows by using an image pyramid and a sliding window object detection algorithm starting with a window size of 224×224 and a step size of 5, (ii) for each sliding window, detect the number of BRISKs found in the sliding window, and (iii) select as the output image the sliding window with the highest number of detected BRISKs in the sliding window.

In some embodiments, a lightness correction operation may include another image transformation operation that is configured to describe a set of operations to replace an L channel of each input image, such as production line image 302, with the L channel of a specimen image for a validation category. The specimen image, for example, may correspond to a product type identifier of a validation category, such as a specimen image for an NDC as selected by a human expert.

In the manner, using at least one of one or more image transformation operations, a transformed image 304 may be generated from a production line image 302 to emphasize one or more target object reflected by the production line image 302. The production line image 302 may reflect the target objects if a first orientation, which, as described herein, may include one or more distortions that may, in some cases, reduces an interpretability of the production line image 302 and transformations thereof (e.g., transformed image 304). For example, the production line image 302 (and the transformed image 304) may be associated with a primary orientation. A primary orientation, for example, may refer to an orientation of the production line image 302 that, if unmodified, will be the orientation of the transformed image 304. The primary orientation may be the orientation of an image as taken (e.g., without modification, etc.) by a camera. An orientation of the production line image 302 may be changed by rotating the production line image 302 to a derivative orientation.

In some embodiments, one or more derivative transformed images 306A-N are generated for the production line image 302. In some examples, each of the derivative transformed images 306A-N may correspond to one of one or more derivative orientations from the primary orientation. The one or more derivative transformed images 306A-N may include a first derivative transformed image 306A, a second derivative transformed image 306B, a third derivative transformed image 306N, and/or the like. The first derivative transformed image 306A may correspond to a first orientation of the one or more derivative orientations that is a rotated from the primary orientation by ninety-degrees. The second derivative transformed image 306B may correspond to a second orientation of the one or more derivative orientations that is a rotated from the primary orientation by one hundred and eighty-degrees. The third derivative transformed image 306N may correspond to a third orientation of the one or more derivative orientations that is a rotated from the primary orientation by two hundred and seventy-degrees. Three derivative transformed images 306A-N are depicted for illustrate only. Any number of derivative transformed images may be generated and correspond to any number of different orientations. In some examples, the number of derivative transformed images 306A-N may be determined based on a performance of a categorical validation machine learning model. For example, the number of derivative transformed images 306A-N may be determined during training to optimize a categorical validation ensemble model performance.

In some embodiments, the derivative orientation is an orientation of an image that is offset (e.g., by one or more degrees of rotation, etc.) from the primary orientation. A derivative orientation, for example, may include an orientation that is rotated from a primary orientation by one or more degrees. By way of example, a derivative orientation may include (i) a ninety-degree (e.g., 90°) derivative orientation that is rotated ninety-degrees in one direction from the primary orientation, (ii) a one-hundred and eighty-degree (e.g., 180°) derivative orientation that is rotated one-hundred and eighty-degrees in one direction from the primary orientation, (iii) a two-hundred and seventy-degree (e.g., 270°) derivative orientation that is rotated two-hundred and seventy-degrees in one direction from the primary orientation, and/or the like.

In some embodiments, the derivative transformed images 306A-N are output images generated by applying one or more transformation operations to a production line image 302. A derivative transformed image 306A-N, for example, may include a cropped image (e.g., cropped using one or more image cropping techniques, etc.), a light adjusted image (e.g., enhanced using one or more lightness correction operations, etc.), a rotated image (e.g., rotated to a derivative orientation, etc.). In some examples, a derivative transformed image 306A-N may include a transformed image 304 that is rotated to a derivative orientation. By way of example, a derivative transformed image may include (i) a ninety-degree derivative orientation image 306A that is rotated ninety-degrees in one direction from the primary orientation, (ii) a one-hundred and eighty-degree derivative orientation image 306B that is rotated one-hundred and eighty-degrees in one direction from the primary orientation, (iii) a two-hundred and seventy-degree derivative orientation image 306N that is rotated two-hundred and seventy-degrees in one direction from the primary orientation, and/or the like.

In some embodiments, a plurality of validation predictions 310A-N is generated for the production line image 302 based on the transformed image 304 and/or the one or more derivative transformed images 306A-N. The validation predictions 310A-N may be generated using a categorical validation machine learning model 308. In some examples, the plurality of validation predictions 310A-N for the production line image 302 may include (i) a first validation prediction 310A corresponding to the transformed image 304, (ii) a second validation prediction 310B corresponding to a first derivative transformed image 306A of the one or more derivative transformed images 306A-N, (iii) a third validation prediction 310C corresponding to a second derivative transformed image 306B of the one or more derivative transformed images 306A-N, (iv) a fourth validation prediction 310N corresponding to a third derivative transformed image 306N of the one or more derivative transformed images 306A-N, and/or the like.

For example, each validation prediction 310A-N may be generated by individually processing one of the transformed images 304 and/or one of the derivative transformed images 306A-N. For example, a first validation prediction 310A may be generated, using the categorical validation machine learning model 308, based on the transformed image 304. As another example, the second validation prediction 310B may be generated, using the categorical validation machine learning model 308, based on the first derivative transformed image 306A. As yet another example, the third validation prediction 310C may be generated, using the categorical validation machine learning model 308, based on the second derivative transformed image 306B. As another example, the fourth validation prediction 310N may be generated, using the categorical validation machine learning model 308, based on the third derivative transformed image 306N.

In some embodiments, the categorical validation machine learning model 308 is a data entity that is configured to describe parameters, hyper-parameters, and/or defined operations of a machine learning model that is configured to determine whether an input production line image corresponds to a target validation category that is associated with the categorical validation machine learning model. In some embodiments, the categorical validation machine learning model 308 is configured to process at least one of (i) an input image (e.g., as a matrix), such as the production line image 302, a transformed image 304, a derivative transformed image 306A-N, and/or the like, (ii) extracted image-based feature values associated with the input image (e.g., as a vector), and/or (iii) one or more physical production attributes for the input image (e.g., as a vector), in order to determine a validation prediction 310A-N for the production line image 302 that describes whether the production line image 302 corresponds to a target validation category that is associated with the categorical validation machine learning model 308.

In some embodiments, the categorical validation machine learning model includes a convolutional neural network, such as a binary classification convolutional neural network, that is characterized by at least one of (i) five layers including four two-dimensional convolutional layers and one flattening layer, (ii) filters that are increased across the two-dimensional convolutional layers to capture patterns and details in the input image, and/or (iii) each 2-dimensional convolutional layer utilizes a rectified linear unit (ReLU) activation function. In some embodiments, each two-dimensional convolution operation in a two-dimensional convolutional layer is followed by a pooling operation (e.g., with a size and stride of two), where dropout values are increased across two dimensional convolutional layers to a maximum value (e.g., a maximum value of 0.7). In some embodiments, the categorical validation machine learning model 308 is trained using a binary cross-entropy loss function, with constant label smoothing (e.g., constant label smoothing at 0.1 to train the model with mislabeled data and with improved overall robustness and accuracy). In some embodiments, to train the categorical validation machine learning model 308, an optimization function such as Adam Optimizer function or a Stochastic gradient descent optimizer function is utilized. While various embodiments of the present disclosure describe that the categorical validation machine learning model 308 includes a convolutional neural network, a person of ordinary skill in the relevant technology will recognize that any machine learning model (e.g., any neural network, such as any pre-trained neural network) may be utilized as part of the categorical validation machine learning model 308.

In some embodiments, an extracted image-based feature leveraged by the categorical validation machine learning model 308 may include a data entity that is configured to describe an extracted feature of a production line image 302, and/or transformation thereof (e.g., transformed image 304, derivative transformed image 306A-N), that is extracted from the image data of the input image associated therewith. Examples of extracted image-based features may include key point descriptors for the input image, such as key point descriptors generated by decomposing the input image to key points that represent a unique feature (e.g., using BRISK feature detection techniques that decompose the production line image 302 (and/or transformed image 304, derivative transformed images 306A-N, etc. associated therewith) to key points that represent a unique feature defined in a 128-vector descriptor).

In some embodiments, a physical production attribute is a data entity that is configured to describe a property associated with production of the production line associated with a production line image 302. Examples of physical production attributes include a pharmacy site location identifier associated with a pharmacy site of a production line item, a fill line number associated with a fill line of a production line item, a camera identifier for a camera device used to capture a production line image 302 of a production line item, attributes describing one or more camera/flash settings for a camera device used to capture a production line image 302 of a production line item, attributes describing date and/or time of capture of a production line image 302 of a production line item, and/or the like.

In some embodiments, validation predictions 310A-N include data entities that are configured to describe a conclusion about whether a corresponding production line image 302 that is associated with the validation predictions 310A-N is associated with a corresponding validation category. For example, the validation prediction 310A-N may describe (i) an affirmative likelihood that a corresponding production line image 302 that is associated with the validation prediction 310A-N describes an object (e.g., pill capsule, etc.) for a validation category and/or (ii) a negative likelihood that a corresponding production line image 302 that is associated with the validation prediction 310A-N does not describe an object for a validation category, and/or the like. By way of example, a validation prediction 310A may include a prediction score indicative of an affirmative and/or negative category likelihood. The prediction score may include a binary number (e.g., 0 or 1), a numerical range, a ratio, a percentage, and/or the like. In some examples, the prediction score may include a number between zero and one.

In some embodiments, a validation prediction 310A-N describes at least one of an affirmative category likelihood for the production line image 302 and/or a negative category likelihood for the production line image 302. In some embodiments, a validation prediction 310A-N describes at least one of a smoothed affirmative likelihood for the production line image 302 and/or a smoothed negative category likelihood for the production line image 302. An affirmative category likelihood may describe a value generated by the categorical validation machine learning model 308 that describes a likelihood that an input image provided as an input to the categorical validation machine learning model 308 (e.g., during training, a training production line image) corresponds to a validation category associated with the categorical validation machine learning model 308. A negative category likelihood may describe a value generated by the categorical validation machine learning model 308 that describes a likelihood that an input image provided as an input to the categorical validation machine learning model 308 (e.g., during training, a training production line image) does not correspond to a validation category associated with the categorical validation machine learning model 308. In some embodiments, the affirmative category likelihood and/or the negative category likelihood are processed using a likelihood smoothing transformation to determine a smoothed affirmative likelihood and/or a smoothed negative category likelihood.

In some embodiments, determining the validation prediction 310A-N includes determining an initial validation score based on one or more outputs of the categorical validation machine learning model 308; determining an adjusted validation score based on adjusting the initial validation score using a false positive penalty weight and/or a false negative penalty weight; and/or determining the validation prediction 310A-N based on the adjusted validation score.

In some embodiments, the production line image 302 is reflective of a production line item associated with a target validation category. In some embodiments, the target validation category is one of a plurality of validation categories associated with a production line. The categorical validation machine learning model 308 may be associated with a categorical validation ensemble model including a plurality of categorical validation machine learning models respectively corresponding to the plurality of validation categories. The categorical validation machine learning model 308 may include a model from the categorical validation ensemble model that corresponds to the target validation category.

In some embodiments, the categorical validation ensemble model is a plurality of categorical machine learning models. A categorical validation ensemble model, for example, may include a separate categorical machine learning model for each validation category associated with a production line. In some examples, for a pharmaceutical production line, a categorical validation ensemble model may include a separate categorical machine learning model for each NDC of a plurality of NDC processed by the pharmaceutical production line.

In some embodiments, a validation category is a data entity that describes a category defined by a subset of image attributes, where validation predictions 310A-N are generated with respect to the validation category. For example, a validation prediction 310A-N may be generated with respect to a particular drug type identifier (e.g., NDC), where the validation predictions 310A-N may describe whether corresponding production line images 302 depict objects (e.g., pill capsules, etc.) associated with the drug type identifier. As another example, validation predictions 310A-N may be generated with respect to a particular drug type identifier and a particular pharmacy site location identifier, where the validation predictions 310A-N may describe whether corresponding production line images 302 depict objects associated with the drug type identifier that are generated at the particular pharmacy site location identifier. As yet another example, validation predictions 310A-N may be generated with respect to a particular drug type identifier, a particular pharmacy site location identifier, and/or a particular fill line number, where the validation predictions 310A-N may describe whether corresponding production line images 302 depict objects associated with the drug type identifier that are generated at the particular fill line number of the particular pharmacy site location identifier. In general, any combination of one or more defined image attributes may be used to characterize a validation category.

In some embodiments, an aggregate validation prediction 312 may be generated based on the plurality of validation predictions 310A-N. The aggregate validation prediction 312 may include an average, minimum, maximum, and/or the like between the plurality of validation predictions 310A-N. By way of example, the first validation prediction 310A may include a first prediction score and the second validation prediction 310B may include a second prediction score. The aggregate validation prediction 312 may include an average of the first prediction score and the second prediction score.

In some embodiments, the aggregate validation prediction 312 is a combination of a plurality of validation predictions 310A-N and/or scores thereof. An aggregate validation prediction 312, for example, may include a single value that represents a plurality of validation predictions 310A-N. An aggregate validation prediction 312 may be generated by applying one or more aggregation operations to the plurality of validation predictions 310A-N. For example, an aggregate validation prediction 312 may include a maximum prediction score, a minimum prediction score, an average prediction score, a median prediction score, and/or any other score for representing an attribute of a plurality of validation predictions 310A-N. By way of example, an aggregate validation prediction 312 may include an average of a plurality of validation predictions 310A-N.

In some embodiments, the performance of a prediction-based action 316 is initiated based on the aggregate validation prediction 312. The prediction-based action 316 may include one of one or more production line routing actions. In some examples, a prediction-based action 316 may be identified from the one or more production line routing actions based on a comparison between the aggregate validation prediction 312 and one or more action thresholds 314. The one or more production line routing actions may include (a) a clearance action associated with a clearance threshold, (b) a reimage action associated with a reimage threshold, (c) an image review action associated with a review threshold, and/or (d) a manual inspection action associated with an inspection threshold. In some examples, the clearance threshold, the reimage threshold, the review threshold, and/or the inspection threshold may define a hierarchical threshold scheme.

In some embodiments, the process control database is a set of one or more data entities (e.g., a set of data entities stored in a distributed manner) that contain data for a database that describes, for each validation category of a set of defined validation categories, an action threshold 314 for the validation category and one or more process control parameters for the validation category, where the action threshold 314 for the validation category may describe a condition that, when satisfied by the validation prediction 310A-N for a production line image 302 with respect to the validation category, causes performance of one or more production line control actions based on one or more process control parameters associated with the validation category.

For example, the action threshold 314 may recommend that, when a validation prediction 310A-N for a production line image 302 with respect to a corresponding validation category exceeds a particular numeric value, the one or more production line control actions for the corresponding validation category should be performed. As another example, the action threshold 314 may recommend that, when a validation prediction 310A-N for a production line image 302 with respect to a corresponding validation category falls below a particular numeric value, the one or more production line control actions for the corresponding validation category should be performed.

In some embodiments, the process control database may describe, for each validation category of a set of defined validation categories, specific image transformation requirements and measurement parameters associated with the validation category, such as properties associated with the crop, enhancement, and measurement transformations for the validation category. In some embodiments, the process control database may describe data associated with each validation category in a row of a relational database, where the row is associated with the validation category. In some embodiments, the process control database may describe data associated with each validation category in a column of a relational database, where the column is associated with the validation category.

In some examples, a process control database may define a hierarchical threshold scheme. The hierarchical threshold scheme may define a plurality of action thresholds 314, each corresponding to a particular prediction-based action 316 associated with a production line. For instance, the hierarchical threshold scheme may define a first action threshold for a first prediction-based action as a first numerical value, range, etc. that, if achieved by a validation prediction 310A-N, aggregate validation prediction 312, and/or the like, may cause a performance of the first prediction-based action. In addition, or alternatively, the hierarchical threshold scheme may define a second action threshold for a second prediction-based action as a second numerical value, range, etc. that, if achieved by a validation prediction 310A-N, aggregate validation prediction 312, and/or the like, may cause a performance of the second prediction-based action. The second action threshold may be less than (or greater than, etc.) the first action threshold, such that a second prediction-based action may be performed in the event that a validation prediction 310A-N, aggregate validation prediction 312, and/or the like achieves a second action threshold but not the first action threshold. In some examples, the hierarchical threshold scheme may define at least one of a clearance threshold, a reimaging threshold, an image review threshold, a manual inspection threshold, and/or the like, each corresponding to a respective prediction-based action.

In some embodiments, a prediction-based action 316 is an action that may be performed for a production line item based on a prediction, such as the validation predictions 310A-N and/or aggregate validation predictions 312 described herein. In some examples, a prediction-based action 316 may include a plurality of line routing actions that each correspond to a different action threshold 314.

In some embodiments, the action threshold 314 is a validation prediction threshold that corresponds to a particular production line routing action. An action threshold 314, for example, may include a numerical range, a numerical value, and/or the like that describes a criterion for evaluating a validation prediction 310A-N and/or aggregate validation prediction 312. An action threshold 314, for example, may include minimum value (e.g., percentage, etc.) for performing a particular production line routing action.

In some embodiments, the production line routing action is a prediction-based action 316 that is performed by one or more control components of a production line. A production line routing action, for example, may include one or more control operations for controlling a motor (and/or other control mechanism) of a conveyance assembly to initiate a movement of a production line item from an origin location to a destination location. A production line routing action may include a movement of a conveyor belt to move a production line item in a forward direction. In addition, or alternatively, a production line routing action may include a movement of one or more diverting assemblies to reroute a production line item on a conveyance assembly.

In some embodiments, a clearance action is a production line routing action that moves a production line item in a forward direction without rerouting the production line item for further inspection. A clearance action, for example, may include a pass routing action allowing the production line item to proceed. In some examples, a clearance action may correspond to a clearance threshold. In some examples, a clearance threshold may be a highest (or lowest, etc.) threshold in a hierarchical threshold scheme.

In some embodiments, a reimage action to a production line routing action that diverts a production line item for further inspection. A reimage action, for example, may include a diverting a production line item to another camera system for performing one or more imaging operations, as described herein, to generate one or more second validation predictions and/or aggregate validation predictions. In some examples, a reimaging action may further include routing a production line item to a shuffling machine to reshuffle one or more contents within the production line item. In some examples, a reimage action may correspond to a reimage threshold. In some examples, a reimage threshold may be a lower (or higher, etc.) threshold relative to a clearance threshold, but higher (or lower, etc.) than one or more other thresholds (e.g., an image review threshold, etc.) in a hierarchical threshold scheme.

In some embodiments, an image review action is a production line routing action that diverts a production line item for further inspection. A manual inspection action, for example, may include a minor routing action which allows the production line item to be verified based on the production line image. For example, a process control action may be triggering an exception that causes a user interface depicting the production line image 302 as well as the physical production attributes of the production line image 302 to be presented to the human inspector. In some examples, an image review action may correspond to an image review threshold. In some examples, an image review threshold may be a lower (or higher, etc.) threshold relative to a reimage threshold, but higher (or lower, etc.) than one or more other thresholds (e.g., a manual inspection threshold, etc.) in a hierarchical threshold scheme.

In some embodiments, a manual inspection action is a production line routing action that diverts a production line item for further inspection. A manual inspection action, for example, may include a major routing action which requires a manual verification of the contents in a production line item. A manual inspection action may include triggering an exception that causes a production line item associated with a production line image 302 to be diverted to a human inspector. A manual inspection action may be triggering an exception that causes a production line item associated with a production line image 302 to be diverted to a human inspector and a user interface depicting the production line image 302 to be presented to the human inspector. In some examples, a manual inspection action may correspond to a manual inspection threshold. In some examples, a manual inspection threshold may be a lowest (or highest) in a hierarchical threshold scheme.

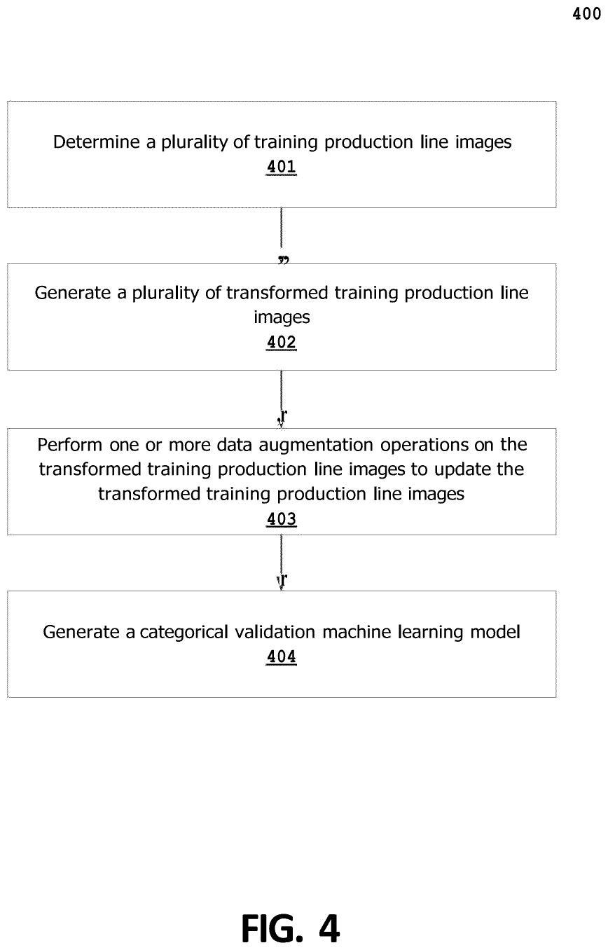

In this manner, using some of the techniques of the present disclosure, one or more predictive insights, such as the validation predictions 310A-N and/or aggregate validation predictions 312, may be leveraged from production line images 302 to intelligently route production line items across a distribution facility. Improved predictive insights may be generated to facilitate accurate prediction-based actions 316 using machine learning models, such as the categorical validation machine learning model 308, and preprocessing image techniques that are directly tailored to the production line items transported within the distribution facility. Example training techniques for generating the categorical validation machine learning models 308 will now further be described with reference to FIGS. 4-9.

### Model Training Operations

FIG. 4 is a flowchart diagram of an example process 400 for generating a categorical validation machine learning model for a target validation category. The process 400 may be implemented by one or more computing devices, entities, and/or systems described herein. For example, via the various steps/operations of the process 400, the computing system 100 may leverage improved model training, configuration, and data augmentation techniques to generate categorical validation machine learning models tailored to a production line environment. By doing so, the process 400 enables improved prediction processes, using trained categorical validation machine learning models, which improve item routing within a distribution facility.

FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence. While various embodiments of the present disclosure describe generating a categorical validation machine learning model as being performed by the same computing entity as the computing entity used to generate validation predictions by a categorical validation machine learning model, a person of ordinary skill in the relevant technology will recognize that in some embodiments a first set of one or more computing entities may generate a categorical validation machine learning model and a second set of one or more computing entities may generate the validation prediction by utilizing the categorical validation machine learning model.

The process 400 begins at step/operation 401 when the computing system 100 determines a plurality of training production line images for the target validation category. In some embodiments, the computing system 100 determines the plurality of training production line images for the target validation category based on a related category subset for the target validation category, as further described below. In some embodiments, if a production line image is associated with a ground-truth label identifying whether the production line image corresponds to a target validation category, the production line image is referred to herein as a “training production line image.”

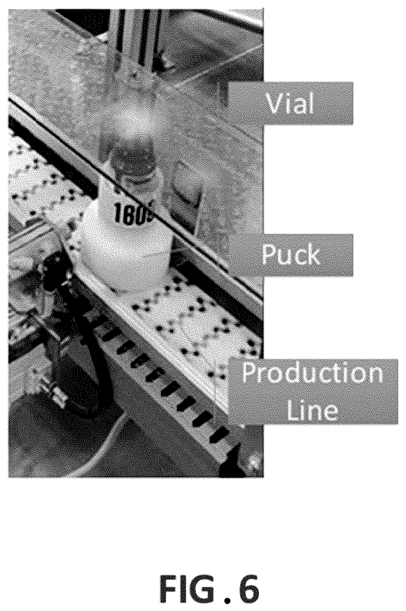

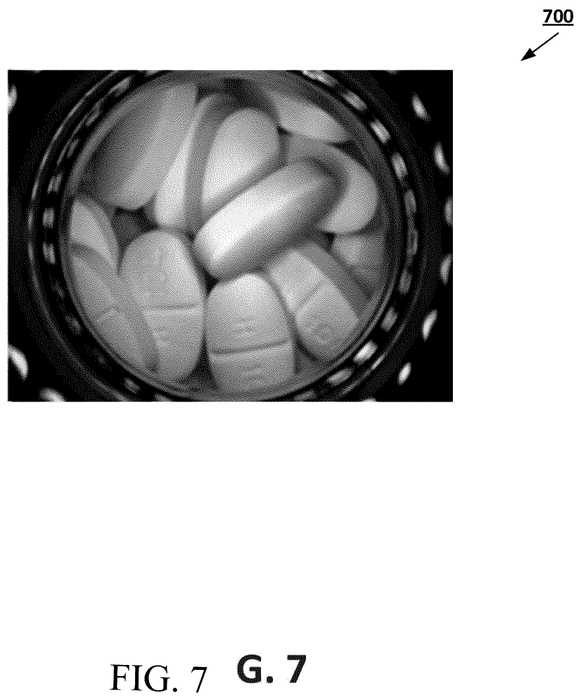

FIG. 6 provides an operational example of a radio frequency-controlled container in a production line in accordance with some embodiments discussed herein. FIG. 7 provides an operational example of a production line image in accordance with some embodiments discussed herein. The production line image 700 is an overhead shot of a pill container ready to be capped and sent out. The white dashes near the outside of the photo are from external lighting. The container itself is a circular feature with amber-orange color near the outside of the image. The production line image 700 also depicts pills outside the depicted container.

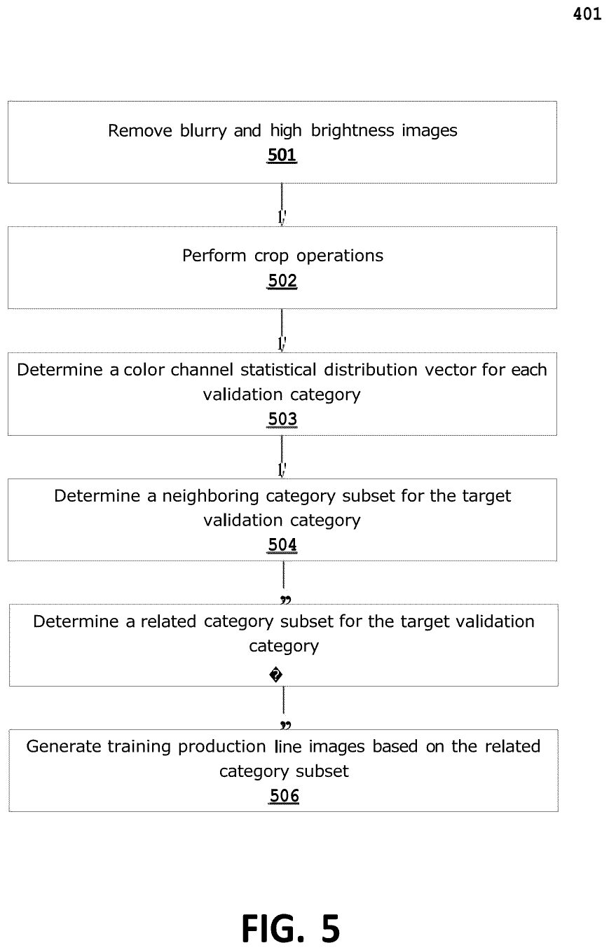

In some embodiments, step/operation 401 may be performed in accordance with the process that is depicted in FIG. 5.

FIG. 5 is a flowchart diagram of an example process for generating a plurality of training production line images in accordance with some embodiments discussed herein. The process that is depicted in FIG. 5 begins at step/operation 501 when the computing system 100 removes blurry and high brightness images from a training image dataset. In some embodiments, determining whether an image is blurry is performed by using a Laplacian of Gaussian Edge Detection algorithm (e.g., by removing images with a variance below six). In some embodiments, determining whether an image is high brightness is performed by using a root mean square (RMS) technique and by removing brightness values that are above a brightness threshold (e.g., a brightness threshold of 200). In some embodiments, removing blurry and high brightness images increases the quality of available training data and provides the opportunity to correct photography issues in production lines.

At step/operation 502, the computing system 100 performs one or more crop operations on each training production line image in the training image dataset to generate a first set of training production line images. Examples of crop operations include center crop operations (e.g., cropping a training production line image to 224×224 pixels in the center of image while maintaining the original aspect ratio), operations configured to crop the training production line image to a specific size (e.g., to a size of 224×224 starting in a predefined location like the top left corner), sliding window intelligent crop operations (e.g., by using an image pyramid and a sliding window object detection algorithm starting with a window size of 224×224 and a step size of five to detect and count the number of Binary Robust Invariant Scalable Keypoints (BRISKs) found in each of the sliding windows and selecting the sliding window containing the maximum number of BRISKs), and/or the like.

At step/operation 503, the computing system 100 determines, for each validation category, a color channel statistical distribution vector based on the one or more labeled production line images for the target validation category. In some embodiments, the computing system 100 first identifies a set of (e.g., a defined number of, such as 1000) training images in the first set of training production line images that are assigned a label associated with the target validation category as the set of labeled production line images for the target validation category, and subsequently determines the color channel statistical distribution vector for the target validation category based on the set of labeled production line images for the target validation category.

In some embodiments, a color channel statistical distribution vector is a data entity that is configured to describe, for each color channel of a set of color channels, a measure of statistical distribution (e.g., an average or other centroid measure) of color values associated with the color channel in pixels of a set of labeled production line images for a corresponding validation category. For example, given a validation category that is associated with a particular NDC identifier, and further given a Red-Green-Blue (RGB) color channel scheme, the color channel statistical distribution vector may describe: (i) an average pixel value for the red channel across labeled production line images that are assigned the particular NDC identifier, (ii) an average pixel value for the green channel across labeled production line images that are assigned the particular NDC identifier, and (iii) an average pixel value for the blue channel across labeled production line images that are assigned the particular NDC identifier. While various embodiments of the present disclosure describe using the color channels of the RGB color channel scheme, a person of ordinary skill in the relevant technology will recognize that other color channel schemes (e.g., Blue-Green-Red (BGR), Hue-Saturation-Lightness (HSL), Hue-Saturation-Value (HSV), the CIELAB color space (LAB), Red-Green-Blue-Alpha (RGBA), and/or the like) may be utilized. In some embodiments, the color channel statistical distribution vector for a validation category may describe statistical distribution measures of labeled production line images for the validation category across color channels defined by two or more color channel schemes.

At step/operation 504, the computing system 100 determines a neighboring category subset of a plurality of defined validation categories for the target validation category based on each color channel statistical distribution vector for a defined validation category. In some embodiments, a neighboring category subset is a data entity that is configured to describe a subset of a set of defined validation categories that are deemed similar to a target validation category based on comparing color channel statistical distribution vectors for the defined validation categories (where the set of defined validation categories includes the target validation category). For example, a neighboring category subset for a target validation category may describe an n-sized subset of a set of defined validation categories whose color channel statistical distribution vectors have the highest measures of similarity to the color channel statistical distribution vector of the target validation category (where n may, for example, be 20). In some embodiments, the measures of similarities of pairs of color channel statistical distribution vectors are determined using k-dimensional tree algorithms.

At step/operation 505, the computing system 100 determines a related category subset of the neighboring category subset. In some embodiments, each defined validation category of the neighboring category subset is also in the related category subset if a shape descriptor data object of the defined validation category matches the shape descriptor object of the target validation category.

In some embodiments, a related category subset is a data entity that is configured to describe a subset of the neighboring category subset for a target validation category, where the subset includes defined validation categories whose production line items are associated with respective shape feature descriptions that are determined to match a shape feature description of a production line item of the target validation category. In some embodiments, each defined validation category of the neighboring category subset is also in the related category subset if a shape descriptor data object of the defined validation category matches the shape descriptor object of the target validation category. A shape descriptor object may describe one or more shape-defining features of a product type identifier associated with a corresponding validation category, such as a shape-defining feature that describes whether pills associated with a pill category are round, oblong, capsule, teardrops, and/or the like.

At step/operation 506, the computing system 100 combines the labeled production line images for each defined validation category in the related category subset (which also includes the labeled production line images for the target validation category itself that is in the related category subset) to generate the plurality of training production line images for the target validation category. In some embodiments, restricting the training set in this manner increases the efficacy of the categorical validation machine learning models to distinguish similar looking pills without increasing the training and runtime costs associated with the categorical validation machine learning models.

Returning to FIG. 4, at step/operation 402, the computing system 100 generates a plurality of transformed training production line images for the target validation category based on the plurality of training production line images for the target validation category. In some embodiments, one or more image transformation operations are applied on the plurality of transformed training production line images to generate the plurality of transformed training production line images. Examples of image transformation operations include crop operations, enhancement/normalization operations, and/or other operations described herein to generate a transformed image.

At step/operation 403, the computing system 100 performs one or more data augmentation operations on the transformed training production line images to update the transformed training production line images. In some embodiments, the data augmentation operations are configured to ensure that a subset of the transformed training production line images that includes the transformed images for the labeled production line images of a target validation category (i.e., those production line images that are deemed to depict production line items associated with the target validation category) satisfies a labeled image count threshold, e.g., is equal to or above a labeled image count threshold of 1000.

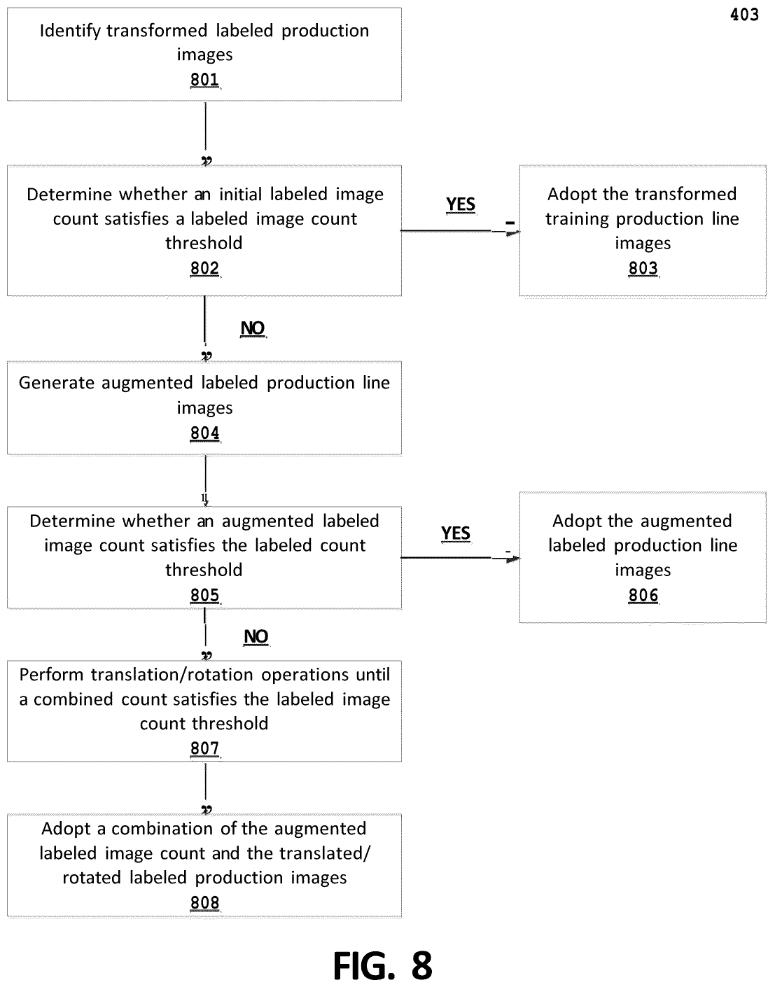

In some embodiments, step/operation 403 is performed in accordance with the process that is depicted in FIG. 8.

FIG. 8 is a flowchart diagram of an example process for performing one or more data augmentation operations on a set of transformed training production line images to update the set of transformed training production line images in accordance with some embodiments discussed herein. The process that is depicted in FIG. 8 begins at step/operation 801 when the computing system 100 identifies a set of transformed labeled production line images for the target validation category from the set of transformed training production line images. The set of transformed labeled production line images may include all of the transformed training production line images that are generated by applying image transformation operations on the labeled production line images for the target validation category. As described above, a labeled production line image for a validation category may be a production line image that is deemed to depict a production line item associated with the validation category.

At step/operation 802, the computing system 100 determines whether an initial labeled image count of the one or more transformed labeled training production line images satisfies (e.g., exceeds) a labeled image count threshold. The initial labeled image count may be the count of the one or more transformed labeled training production line images for the target validation category. An example of a labeled image count threshold is 1000.

At step/operation 803, in response to determining that the initial labeled image count satisfies the labeled image count threshold, the computing system 100 adopts the transformed training production line images without generating any new images. In some embodiments, because the initial labeled image count satisfies the labeled image count threshold, the computing system 100 is configured to skip generating new images as sufficient labeled images are deemed to exist among the transformed training production line images.

At step/operation 804, in response to determining that the initial labeled image count fails to satisfy the labeled image count threshold, the computing system 100 first performs one or more sliding window operations across each transformed labeled training production line image to generate a plurality of augmented labeled production line images. In some embodiments, the sliding window operations are defined by a sliding window of a specific size, such as a sliding window of 224×224 pixels. The augmented labeled production line images may either include both the transformed labeled production line images and the newly-generated images generated using the sliding window operations, or may just include the latter.

At step/operation 805, in response to determining that the initial labeled image count fails to satisfy the labeled image count threshold, subsequent to step/operation 804, the computing system 100 determines whether an augmented labeled image count of the plurality of augmented labeled production line images satisfies the labeled image count threshold. The augmented labeled image count may describe the count of the augmented labeled production line images. An example of a labeled image count threshold is 1000.

At step/operation 806, in response to determining that the initial labeled image count fails to satisfy the labeled image count threshold, but the augmented labeled image count satisfies the labeled image count threshold, the computing system 100 adopts the augmented labeled production line images as the transformed training production line images. In some embodiments, because sliding window operations generated sufficient new images, the new images (either individually or along with the initial transformed training production line images) are adopted as the transformed training production line images used for training the categorical validation machine learning model.

At step/operation 807, in response to determining that the initial labeled image count fails to satisfy the labeled image count threshold and that the augmented labeled image count also fails to satisfy the labeled image count threshold, the computing system 100 performs one or more translation/rotation operations on the plurality of augmented labeled production line images to generate one or more translated/rotated labeled production line images until a combined count of the plurality of augmented labeled production line images and the one or more translated/rotated labeled production line images satisfies the labeled image count threshold. In some embodiments, as many iterations of an image translation/rotation routine are performed until a first iteration in which the combined count described above satisfies the labeled image count threshold. An example of a labeled image count threshold is 1000.

At step/operation 808, in response to determining that the initial labeled image count fails to satisfy the labeled image count threshold and the augmented labeled image count also fails to satisfy the labeled image count threshold, subsequent to step/operation 807, the computing system 100 generates the plurality of transformed training production line images based on the plurality of augmented labeled production line images and the one or more translated/rotated labeled production line images. In some embodiments, the computing system 100 combines the plurality of augmented labeled production line images and the one or more translated/rotated labeled production line images to generate the plurality of transformed training production line images.

Returning to FIG. 4, at step/operation 404, the computing system 100 generates the categorical validation machine learning model based on the plurality of transformed training production line images. In some embodiments, the computing system 100 trains the categorical validation machine learning model as a machine learning model that is configured to process feature data associated with an input production line image in order to generate a validation prediction about whether the input production line image is an image of a production line item associated with a corresponding target validation category.

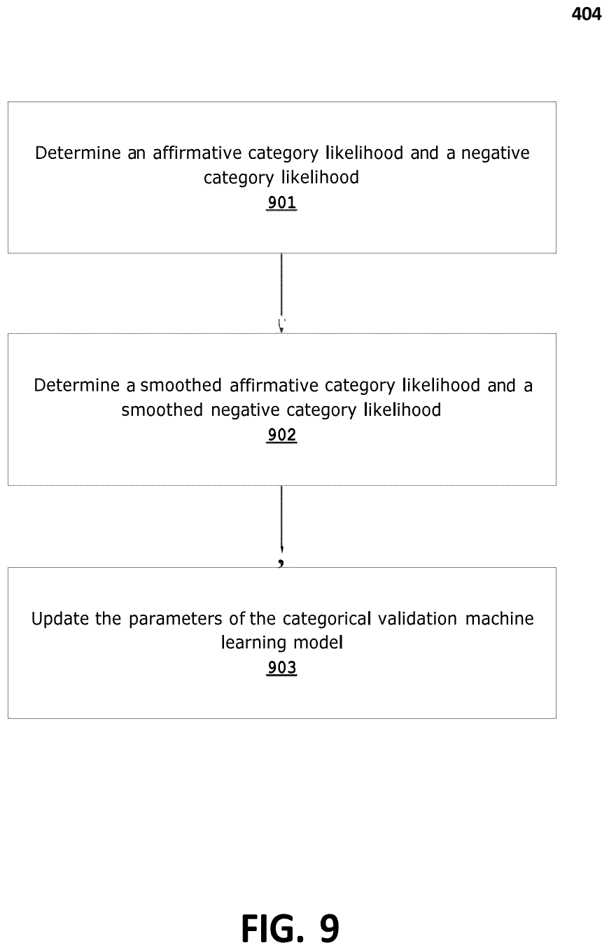

In some embodiments, step/operation 404 may be performed in accordance with the process that is depicted in FIG. 9.

FIG. 9 is a flowchart diagram of an example process for updating parameters of a categorical validation machine learning model based on a transformed training production line image in accordance with some embodiments discussed herein. The process that is depicted in FIG. 9 begins at step/operation 901 when the computing system 100 processes the training production line image using the categorical validation machine learning model to determine an affirmative category likelihood for the training production line image and a negative category likelihood for the training production line image. In some embodiments, processing the training production line image using the categorical validation machine learning model comprises processing extracted image-based features for the training production line image and one or more physical production attributes for the training production line image.

The affirmative category likelihood for the training production line image may describe a value generated by the categorical validation machine learning model that describes a likelihood that a production line image provided as an input to the categorical validation machine learning model (e.g., during training, a training production line image) corresponds to a validation category associated with the categorical validation machine learning model. The negative category likelihood for the training production line image may describe a value generated by the categorical validation machine learning model that describes a likelihood that a production line image provided as an input to the categorical validation machine learning model (e.g., during training, a training production line image) does not correspond to a validation category associated with the categorical validation machine learning model. In some embodiments, the affirmative category likelihood and the negative category likelihood are processed using a likelihood smoothing transformation to determine a smoothed affirmative likelihood and a smoothed negative category likelihood.

At step/operation 902, the computing system 100 processes the affirmative category likelihood and the negative category likelihood using a likelihood smoothing transformation to determine a smoothed affirmative likelihood and a smoothed negative category likelihood. The likelihood smoothing transformation may be configured to adjust the affirmative category likelihood and the negative category likelihood using class weights that represent expected likelihoods of observation of affirmative association of input production line images with the validation category for the categorical validation machine learning model and negative association of input production line images with the validation category for the categorical validation machine learning model. For example, the likelihood smoothing transformation may comprise a log functions that apply logarithmic operations based on the noted class weights (e.g., with mu tuning for the noted log functions set to a defined value, such as to 0.15).

At step/operation 903, the computing system 100 updates the parameters of the categorical validation machine learning model based on the smoothed affirmative category likelihood and the smoothed negative category likelihood. In some embodiments, the parameters of the categorical validation machine learning model are updated in a manner that is configured to minimize a loss function determined based on a measure of deviation of the smoothed affirmative category likelihood and the smoothed negative category likelihood with a ground-truth label for the training production line image, where the ground-truth label describes whether the training production line image is associated with the validation category that is associated with the categorical validation machine learning model.

Once trained, categorical validation machine learning models enable efficiently and reliably performing conformance monitoring of a production line in order to determine defective/non-conformant production line items. By enabling conformance monitoring of a production line, various embodiments of the present disclosure reduce the cost to production line control systems resulting from manual conformance monitoring and remove the need for operations needed to enable human agents to perform manual conformance monitoring. Moreover, by enabling conformance monitoring of a production line, various embodiments of the present disclosure reduce or remove the need for operations needed to address the presence of defective products resulting from unreliable conformance monitoring of the production line, such as operations needed to enable human agents to perform manual conformance monitoring of later-stage products that exist in a production process after the production line. By enabling the noted functionalities and associated advantages, various embodiments of the present disclosure reduce the operational load on production line control systems and thus improve the operational efficiency and the operational reliability of the noted production line control systems.

### Prediction-Based Action Operations

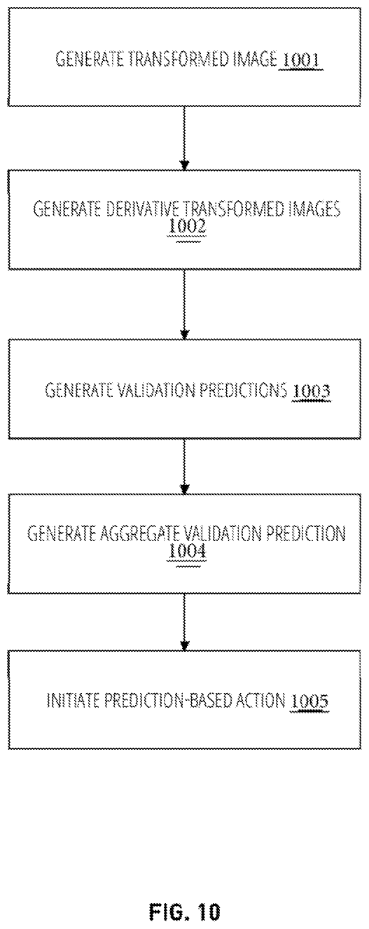

FIG. 10 is a flowchart showing an example prediction-based action process 1000 for intelligently initiating actions within a distribution facility in accordance with some embodiments discussed herein. The flowchart depicts a prediction process 1000 for improving the distribution operations within a distribution facility. The process 1000 may be implemented by one or more computing devices, entities, and/or systems described herein. For example, via the various steps/operations of the process 1000, the computing system 100 may leverage improved image processing techniques to generate predictive insights tailored to a distribution facility. By doing so, the process 1000 enables an automated routing process within a distribution facility to improve facility throughput, while maintaining strict compliance standards.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence. While various embodiments of the present disclosure describe generating a categorical validation machine learning model as being performed by the same computing entity as the computing entity used to generate validation predictions by a categorical validation machine learning model, a person of ordinary skill in the relevant technology will recognize that in some embodiments a first set of one or more computing entities may generate a categorical validation machine learning model and a second set of one or more computing entities may generate the validation prediction by utilizing the categorical validation machine learning model.

In some embodiments, the process 1000 includes, at step/operation 1001, generating transformed images. For example, a computing system 100 may generate a transformed image from a production line image corresponding to a primary orientation.

In some embodiments, the process 1000 includes, at step/operation 1002, generating derivative transformed images. For example, a computing system 100 may generate one or more derivative transformed images for the production line image, each corresponding to one of one or more derivative orientations from the primary orientation. For example, the one or more derivative transformed images may include a first derivative transformed image, a second derivative transformed image, and/or a third derivative transformed image. In some examples, a first derivative transformed image may correspond to a first orientation of the one or more derivative orientations that is a rotated from the primary orientation by ninety-degrees, a second derivative transformed image may correspond to a second orientation of the one or more derivative orientations that is a rotated from the primary orientation by one hundred and eighty-degrees, and/or a third derivative transformed image may correspond to a third orientation of the one or more derivative orientations that is a rotated from the primary orientation by two hundred and seventy-degrees.

In some embodiments, the process 1000 includes, at step/operation 1003, generating validation predictions. For example, a computing system 100 may generate, using a categorical validation machine learning model, a plurality of validation predictions for the production line image based on the transformed image and the one or more derivative transformed images. In some examples, the production line image may be reflective of a production line item associated with a target validation category and the categorical validation machine learning model may correspond to the target validation category. The target validation category, for example, may be one of a plurality of validation categories associated with a production line. The categorical validation machine learning model may be associated with a categorical validation ensemble model including a plurality of categorical validation machine learning models respectively corresponding to the plurality of validation categories.

In some examples, the plurality of validation predictions for the production line image may include (i) a first validation prediction corresponding to the transformed image and/or (ii) a second validation prediction corresponding to a first derivative transformed image of the one or more derivative transformed images. In some examples, the computing system 100 may generate, using the categorical validation machine learning model, the first validation prediction based on the transformed image. In addition, or alternatively, the computing system 100 may generate, using the categorical validation machine learning model, the second validation prediction based on the first derivative transformed image.

In some embodiments, the process 1000 includes, at step/operation 1004, generating aggregate validation predictions. For example, a computing system 100 may generate an aggregate validation prediction based on the plurality of validation predictions. For example, a first validation prediction may include a first prediction score, a second validation prediction may include a second prediction score, and the aggregate validation prediction may include an average of the first prediction score and the second prediction score.

In some embodiments, the process 1000 includes, at step/operation 1005, initiating prediction-based actions. For example, a computing system 100 may initiate the performance of the prediction-based action based on the aggregate validation prediction.

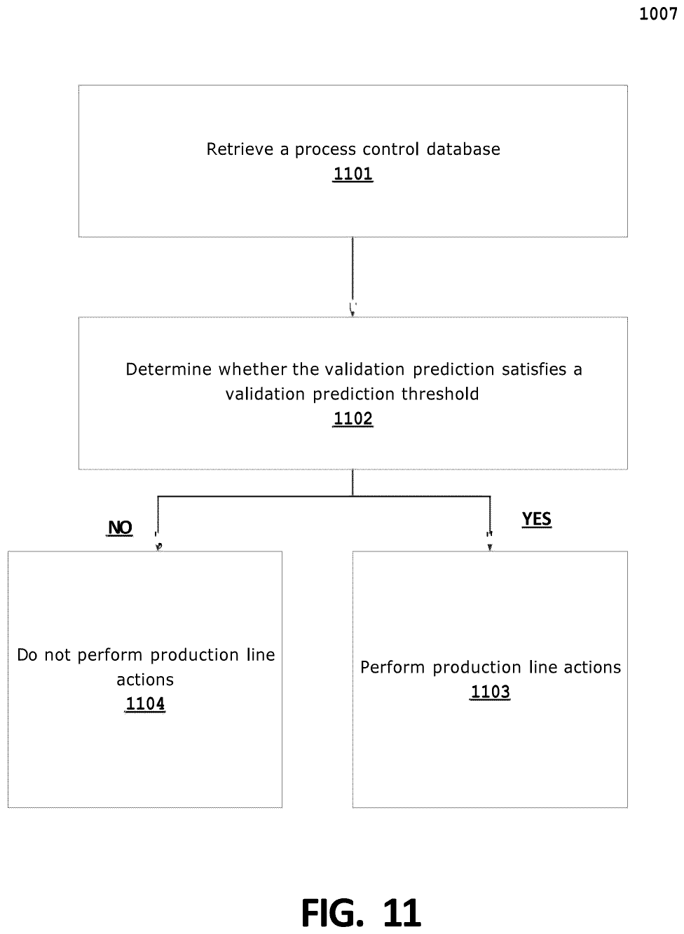

In some embodiments, step/operation 1005 may be performed in accordance with the process that is depicted in FIG. 11.

FIG. 11 is a flowchart diagram of an example process for performing one or more prediction-based actions based on a validation prediction for an input production line image with respect to a target validation category in accordance with some embodiments discussed herein. The process that is depicted in FIG. 11 may begin at step/operation 1101 when the computing system 100 retrieves a process control database that describes a validation prediction threshold for the validation category and one or more process control parameters for the validation category. The process control database may describe, for each validation category of a set of defined validation categories, the validation prediction threshold for the validation category and the one or more process control parameters for the validation category, where the validation prediction threshold for the validation category may describe a condition that, when satisfied by the validation prediction for a production image line image with respect to the validation category, causes performance of one or more production line control actions based on one or more process control parameters associated with the validation category.

For example, a prediction-based action may include one of one or more production line routing actions. In some examples, a prediction-based action may be identified from the one or more production line routing actions based on a comparison between the aggregate validation prediction and one or more action thresholds. For instance, the one or more production line routing actions may include (a) a clearance action associated with a clearance threshold, (b) a reimage action associated with a reimage threshold, (c) an image review action associated with a review threshold, and/or (d) a manual inspection action associated with an inspection threshold. In some examples, the clearance threshold, the reimage threshold, the review threshold, and/or the inspection threshold define a hierarchical threshold scheme.

At step/operation 1102, the computing system 100 determines whether the validation prediction, aggregate validation prediction, and/or the like, satisfies a respective action threshold described by the process control database for the validation category. At step/operation 1103, in response to determining that the validation prediction, the aggregate validation prediction, and/or the like satisfies the respective threshold, the computing system 100 may perform one or more one or more production line control actions based on one or more process control parameters associated with the validation category as described by the process control database. At step/operation 1104, in response to determining that the validation prediction fails to satisfy the validation prediction threshold, the computing system 100 may not perform the one or more production line control actions.

In some embodiments, performing the process control actions includes generating an action signal for the production line item associated with the production line image, such as generating an action signal on a commercial pharmacy production fill line after a pill bottle has been filled and imaged. The action signal may represent an exception signal, a no exception signal, an error signal, and/or the like. In some embodiments, an internet browser-based interface is provided to maintain and update values in the process control database. This interface may enable a pharmacy operations team to dynamically tune the number of exceptions produced for review by a human pharmacist as it allows them to change the thresholding parameters and rules that generate exceptions in near real time.

Accordingly, as described above, categorical validation machine learning models, and the image preprocessing techniques of the present disclosure, enable efficiently and reliably performing conformance monitoring of a production line in order to determine defective/non-conformant production line items. By enabling conformance monitoring of a production line, various embodiments of the present disclosure reduce the cost to production line control systems resulting from manual conformance monitoring and remove the need for operations needed to enable human agents to perform manual conformance monitoring. Moreover, by enabling conformance monitoring of a production line, various embodiments of the present disclosure reduce or remove the need for operations needed to address the presence of defective products resulting from unreliable conformance monitoring of the production line, such as operations needed to enable human agents to perform manual conformance monitoring of later-stage products that exist in a production process after the production line. By enabling the noted functionalities and associated advantages, various embodiments of the present disclosure reduce the operational load on production line control systems and thus improve the operational efficiency and the operational reliability of the noted production line control systems.

In some embodiments, after an initial evaluation of a production line item is completed, a proposed system and/or a human agent empties a pill bottle, then refills the pill bottle, and then repeats the evaluation. In some embodiments, one or more of the action thresholds described herein may be optimized using specific techniques including by using relative economics involved in the costs of a false positive and a false negative. In some embodiments, categorical validation machine learning models may be retrained using evaluation results (e.g., model predictions and/or human evaluation results) to improve prediction results. In some embodiments, a proposed system evaluates crops of the same vial to detect foreign bodies or instances of incorrect pills in otherwise correctly filled pill bottles, and causes an exception when a “foreign object” (e.g., a loose screw from the machinery or a piece of lint) is detected in a production line image using a new exception type in addition to the exception types described above.

In some embodiments, performing the prediction-based actions comprises identifying a second input production line image of a production line item after emptying of the production line image and refilling of the production line image; determining a second validation determination based on the second production line image; and performing one or more second prediction-based actions based on the second validation prediction. In some embodiments, performing the prediction-based actions comprises determining a foreign object validation prediction for the input production line image; and determining whether to generate a foreign object exception based on the foreign object validation prediction. In some embodiments, performing the prediction-based actions comprises determining an incorrect pill validation prediction for the input production line image; and determining whether to generate an incorrect pill exception based on the incorrect pill validation prediction.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method comprising generating, by one or more processors, a transformed image from a production line image corresponding to a primary orientation; generating, by the one or more processors, one or more derivative transformed images for the production line image, each corresponding to one of one or more derivative orientations from the primary orientation; generating, by the one or more processors and using a categorical validation machine learning model, a plurality of validation predictions for the production line image based on the transformed image and the one or more derivative transformed images; generating, by the one or more processors, an aggregate validation prediction based on the plurality of validation predictions; and initiating, by the one or more processors, the performance of a prediction-based action based on the aggregate validation prediction.

Example 2. The computer-implemented method of example 1, wherein the production line image is reflective of a production line item associated with a target validation category and the categorical validation machine learning model corresponds to the target validation category.

Example 3. The computer-implemented method of example 2, wherein the target validation category is one of a plurality of validation categories associated with a production line and the categorical validation machine learning model is associated with a categorical validation ensemble model comprising a plurality of categorical validation machine learning models respectively corresponding to the plurality of validation categories.

Example 4. The computer-implemented method of any of the preceding examples, wherein the one or more derivative transformed images comprise a first derivative transformed image, a second derivative transformed image, or a third derivative transformed image and wherein the first derivative transformed image corresponds to a first orientation of the one or more derivative orientations that is a rotated from the primary orientation by ninety-degrees, the second derivative transformed image corresponds to a second orientation of the one or more derivative orientations that is a rotated from the primary orientation by one hundred and eighty-degrees, and the third derivative transformed image corresponds to a third orientation of the one or more derivative orientations that is a rotated from the primary orientation by two hundred and seventy-degrees.

Example 5. The computer-implemented method of any of the preceding examples, wherein the plurality of validation predictions for the production line image comprises (i) a first validation prediction corresponding to the transformed image and (ii) a second validation prediction corresponding to a first derivative transformed image of the one or more derivative transformed images.

Example 6. The computer-implemented method of example 5, wherein generating the plurality of validation predictions comprises generating, using the categorical validation machine learning model, the first validation prediction based on the transformed image; and generating, using the categorical validation machine learning model, the second validation prediction based on the first derivative transformed image.

Example 7. The computer-implemented method of examples 5 or 6, wherein the first validation prediction comprises a first prediction score, the second validation prediction comprises a second prediction score, and the aggregate validation prediction comprises an average of the first prediction score and the second prediction score.

Example 8. The computer-implemented method of any of the preceding examples, wherein the prediction-based action comprises one of one or more production line routing actions.

Example 9. The computer-implemented method of example 8, wherein the prediction-based action is identified from the one or more production line routing actions based on a comparison between the aggregate validation prediction and one or more action thresholds.

Example 10. The computer-implemented method of example 9, wherein (i) the one or more production line routing actions comprise (a) a clearance action associated with a clearance threshold, (b) a reimage action associated with a reimage threshold, (c) an image review action associated with a review threshold, and (d) a manual inspection action associated with an inspection threshold, and (ii) the clearance threshold, the reimage threshold, the review threshold, and the inspection threshold define a hierarchical threshold scheme.

Example 11. A computing system comprising memory and one or more processors communicatively coupled to the memory, the one or more processors configured to generate a transformed image from a production line image corresponding to a primary orientation; generate one or more derivative transformed images for the production line image, each corresponding to one of one or more derivative orientations from the primary orientation; generate, using a categorical validation machine learning model, a plurality of validation predictions for the production line image based on the transformed image and the one or more derivative transformed images; generate an aggregate validation prediction based on the plurality of validation predictions; and initiate the performance of a prediction-based action based on the aggregate validation prediction.

Example 12. The computing system of example 11, wherein the production line image is reflective of a production line item associated with a target validation category and the categorical validation machine learning model corresponds to the target validation category.

Example 13. The computing system of example 12, wherein the target validation category is one of a plurality of validation categories associated with a production line and the categorical validation machine learning model is associated with a categorical validation ensemble model comprising a plurality of categorical validation machine learning models respectively corresponding to the plurality of validation categories.

Example 14. The computing system of any of examples 11 to 13, wherein the one or more derivative transformed images comprise a first derivative transformed image, a second derivative transformed image, or a third derivative transformed image and wherein the first derivative transformed image corresponds to a first orientation of the one or more derivative orientations that is a rotated from the primary orientation by ninety-degrees, the second derivative transformed image corresponds to a second orientation of the one or more derivative orientations that is a rotated from the primary orientation by one hundred and eighty-degrees, and the third derivative transformed image corresponds to a third orientation of the one or more derivative orientations that is a rotated from the primary orientation by two hundred and seventy-degrees.

Example 15. The computing system of any of examples 11 to 14, wherein the plurality of validation predictions for the production line image comprises (i) a first validation prediction corresponding to the transformed image and (ii) a second validation prediction corresponding to a first derivative transformed image of the one or more derivative transformed images.

Example 16. The computing system of example 15, wherein generating the plurality of validation predictions comprises generating, using the categorical validation machine learning model, the first validation prediction based on the transformed image; and generating, using the categorical validation machine learning model, the second validation prediction based on the first derivative transformed image.

Example 17. The computing system of examples 15 or 16, wherein the first validation prediction comprises a first prediction score, the second validation prediction comprises a second prediction score, and the aggregate validation prediction comprises an average of the first prediction score and the second prediction score.

Example 18. One or more non-transitory computer-readable storage media including instructions that, when executed by one or more processors, cause the one or more processors to generate a transformed image from a production line image corresponding to a primary orientation; generate one or more derivative transformed images for the production line image, each corresponding to one of one or more derivative orientations from the primary orientation; generate, using a categorical validation machine learning model, a plurality of validation predictions for the production line image based on the transformed image and the one or more derivative transformed images; generate an aggregate validation prediction based on the plurality of validation predictions; and initiate the performance of a prediction-based action based on the aggregate validation prediction.

Example 19. The one or more non-transitory computer-readable storage media of example 18, wherein the prediction-based action comprises one of one or more production line routing actions.

Example 20. The one or more non-transitory computer-readable storage media of example 19, wherein the prediction-based action is identified from the one or more production line routing actions based on a comparison between the aggregate validation prediction and one or more action thresholds.

1. A computer-implemented method comprising:
generating, by one or more processors, a transformed image from a production line image corresponding to a primary orientation;
generating, by the one or more processors, one or more derivative transformed images for the production line image, each corresponding to one of one or more derivative orientations from the primary orientation;
generating, by the one or more processors and using a categorical validation machine learning model, a plurality of validation predictions for the production line image based on the transformed image and the one or more derivative transformed images;
generating, by the one or more processors, an aggregate validation prediction based on the plurality of validation predictions; and
initiating, by the one or more processors, the performance of a prediction-based action based on the aggregate validation prediction.

2. The computer-implemented method of claim 1, wherein the production line image is reflective of a production line item associated with a target validation category and the categorical validation machine learning model corresponds to the target validation category.

3. The computer-implemented method of claim 2, wherein the target validation category is one of a plurality of validation categories associated with a production line and the categorical validation machine learning model is associated with a categorical validation ensemble model comprising a plurality of categorical validation machine learning models respectively corresponding to the plurality of validation categories.

4. The computer-implemented method of claim 1, wherein the one or more derivative transformed images comprise a first derivative transformed image, a second derivative transformed image, or a third derivative transformed image and wherein:
the first derivative transformed image corresponds to a first orientation of the one or more derivative orientations that is a rotated from the primary orientation by ninety-degrees,
the second derivative transformed image corresponds to a second orientation of the one or more derivative orientations that is a rotated from the primary orientation by one hundred and eighty-degrees, and
the third derivative transformed image corresponds to a third orientation of the one or more derivative orientations that is a rotated from the primary orientation by two hundred and seventy-degrees.

5. The computer-implemented method of claim 1, wherein the plurality of validation predictions for the production line image comprises (i) a first validation prediction corresponding to the transformed image and (ii) a second validation prediction corresponding to a first derivative transformed image of the one or more derivative transformed images.

6. The computer-implemented method of claim 5, wherein generating the plurality of validation predictions comprises:
generating, using the categorical validation machine learning model, the first validation prediction based on the transformed image; and
generating, using the categorical validation machine learning model, the second validation prediction based on the first derivative transformed image.

7. The computer-implemented method of claim 5, wherein the first validation prediction comprises a first prediction score, the second validation prediction comprises a second prediction score, and the aggregate validation prediction comprises an average of the first prediction score and the second prediction score.

8. The computer-implemented method of claim 1, wherein the prediction-based action comprises one of one or more production line routing actions.

9. The computer-implemented method of claim 8, wherein the prediction-based action is identified from the one or more production line routing actions based on a comparison between the aggregate validation prediction and one or more action thresholds.

10. The computer-implemented method of claim 9, wherein:
(i) the one or more production line routing actions comprise (a) a clearance action associated with a clearance threshold, (b) a reimage action associated with a reimage threshold, (c) an image review action associated with a review threshold, and (d) a manual inspection action associated with an inspection threshold, and
(ii) the clearance threshold, the reimage threshold, the review threshold, and the inspection threshold define a hierarchical threshold scheme.

11. A computing system comprising memory and one or more processors communicatively coupled to the memory, the one or more processors configured to:
generate a transformed image from a production line image corresponding to a primary orientation;
generate one or more derivative transformed images for the production line image, each corresponding to one of one or more derivative orientations from the primary orientation;
generate, using a categorical validation machine learning model, a plurality of validation predictions for the production line image based on the transformed image and the one or more derivative transformed images;
generate an aggregate validation prediction based on the plurality of validation predictions; and
initiate the performance of a prediction-based action based on the aggregate validation prediction.

12. The computing system of claim 11, wherein the production line image is reflective of a production line item associated with a target validation category and the categorical validation machine learning model corresponds to the target validation category.

13. The computing system of claim 12, wherein the target validation category is one of a plurality of validation categories associated with a production line and the categorical validation machine learning model is associated with a categorical validation ensemble model comprising a plurality of categorical validation machine learning models respectively corresponding to the plurality of validation categories.

14. The computing system of claim 11, wherein the one or more derivative transformed images comprise a first derivative transformed image, a second derivative transformed image, or a third derivative transformed image and wherein:
the first derivative transformed image corresponds to a first orientation of the one or more derivative orientations that is a rotated from the primary orientation by ninety-degrees,
the second derivative transformed image corresponds to a second orientation of the one or more derivative orientations that is a rotated from the primary orientation by one hundred and eighty-degrees, and
the third derivative transformed image corresponds to a third orientation of the one or more derivative orientations that is a rotated from the primary orientation by two hundred and seventy-degrees.

15. The computing system of claim 11, wherein the plurality of validation predictions for the production line image comprises (i) a first validation prediction corresponding to the transformed image and (ii) a second validation prediction corresponding to a first derivative transformed image of the one or more derivative transformed images.

16. The computing system of claim 15, wherein generating the plurality of validation predictions comprises:
generating, using the categorical validation machine learning model, the first validation prediction based on the transformed image; and
generating, using the categorical validation machine learning model, the second validation prediction based on the first derivative transformed image.

17. The computing system of claim 15, wherein the first validation prediction comprises a first prediction score, the second validation prediction comprises a second prediction score, and the aggregate validation prediction comprises an average of the first prediction score and the second prediction score.

18. One or more non-transitory computer-readable storage media including instructions that, when executed by one or more processors, cause the one or more processors to:
generate a transformed image from a production line image corresponding to a primary orientation;
generate one or more derivative transformed images for the production line image, each corresponding to one of one or more derivative orientations from the primary orientation;
generate, using a categorical validation machine learning model, a plurality of validation predictions for the production line image based on the transformed image and the one or more derivative transformed images;
generate an aggregate validation prediction based on the plurality of validation predictions; and
initiate the performance of a prediction-based action based on the aggregate validation prediction.

19. The one or more non-transitory computer-readable storage media of claim 18, wherein the prediction-based action comprises one of one or more production line routing actions.

20. The one or more non-transitory computer-readable storage media of claim 19, wherein the prediction-based action is identified from the one or more production line routing actions based on a comparison between the aggregate validation prediction and one or more action thresholds.
